(19) United States
(12) Patent Application Publication
(10) Pub. No.: US 2004/0071211 A1
(43) Pub. Date: Apr. 15, 2004

(54) Video production system with mixed frame removal

(76) Inventor: Kinya Washino, Dumont, NJ (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/418,341

(22) Filed: Apr. 18, 2003

Related U.S. Application Data
(63) Continuation-in-part of application No. 09/886,685, filed on Jun. 21, 2001.
Application No. 09/886,685 is a continuation-in-part of application No. 09/305,953, filed on May 6, 1999, now Pat. No. 6,370,198.
Application No. 09/305,953 is a continuation-in-part of application No. 08/834,912, filed on Apr. 7, 1997, now Pat. No. 5,999,220.
(60) Provisional application No. 60/373,483, filed on Apr. 18, 2002.

(51) Int. Cl. H04N 7/12

(52) U.S. Cl. 375/240.01; 348/445; 348/459

(57) ABSTRACT

In an audio-video production system, frame rate transformation is performed so as to simplify editing and/or compression. In the preferred embodiments, the frames surrounding the selected edit points at a scene change are buffered to permit reconstruction, if necessary, to produce “pure” rather than mixed frames. The frames then are intelligently selected or constructed using techniques such as field or frame dropping, frame repeating, and so forth, as necessary. This technique may be applied both to the series of frames leading up to an edit point, and also to the series of frames which follow the edit point.

### REFERENCE TO RELATED APPLICATIONS

This application is a continuation-in-part of U.S. patent application Ser. No. 09/886,685, filed Jun. 21, 2001, which is a continuation-in-part of U.S. patent application Ser. No. 09/305,953, filed May 6, 1999, now U.S. Pat. No. 6,370,198 B1, which is a continuation-in-part of U.S. Ser. No. 08/834,912, filed Apr. 7, 1997, now U.S. Pat. No. 5,999,220. This application also claims priority from U.S. Provisional Patent Application Serial No. 60/373,483, filed Apr. 18, 2002. The entire content of each patent and application is incorporated herein by reference.

### FIELD OF THE INVENTION

This invention relates generally to video production, photographic image processing, and computer graphics, and, more particularly, to a multi-format digital video production system that improves editing and other manipulations by buffering frames surrounding the selected edit points at a scene change so that the frames can be reconstructed, if necessary, to produce pure rather than mixed frames.

### BACKGROUND OF THE INVENTION

As the number of television channels available through various program delivery methods (cable TV, home video, broadcast, etc.) continues to proliferate, the demand for programming, particularly high-quality HDTV-format programming, presents special challenges, both technical and financial, to program producers. While the price of professional editing and image manipulation equipment continues to increase, due to the high cost of research and development and other factors, general-purpose hardware, including personal computers, can produce remarkable effects at a cost well within the reach of non-professionals.

In terms of dedicated equipment, attention has traditionally focused on the development of two kinds of professional image-manipulation systems: those intended for the highest quality levels to support film effects, and those intended for television broadcast to provide “full 35 mm theatrical film quality,” within the realities and economics of present broadcasting systems. Conventional thinking holds that 35 mm theatrical film quality as projected in theaters is equivalent to 1200 or more lines of resolution, whereas camera negatives present 2500 or more lines. As a result, image formats under consideration have been directed towards video systems having 2500 or more scan lines for high-level production, with hierarchies of production, HDTV broadcast, and NTSC and PAL compatible standards which are derived by down-converting these formats. Most proposals employ progressive scanning, although interlace is considered an acceptable alternative as part of an evolutionary process. Another important issue is adaptability to computer-graphics-compatible formats.

The inventions described herein follow in a long line of patents directed to audio/video production systems that facilitate professional quality image manipulation and editing, preferably using enhanced general-purpose hardware. RE38,079, a re-issue of U.S. Pat. No. 5,537,157, filed Aug. 30, 1994 and incorporated herein by reference, describes how a video program may be translated into any of a variety of graphics or television formats, including NTSC, PAL, SECAM and HDTV, and stored as data-compressed images, using any of several commercially available methods such as Motion JPEG, MPEG, etc. In the preferred embodiment, specialized graphics processing capabilities are included in a high-performance personal computer or workstation, enabling the user to edit and manipulate an input video program and produce an output version of the program in a final format which may have a different frame rate, pixel dimensions, or both. An internal production format is chosen which provides the greatest compatibility with existing and planned formats associated with standard and widescreen television, high-definition television, and film. For compatibility with film, the frame rate of the internal production format is preferably 24 fps. Images are re-sized by the system to larger or smaller dimensions so as to fill the particular needs of individual applications, and frame rates are adapted by inter-frame interpolation or by traditional schemes, including “3:2 pull-down” for 24-to-30 fps conversions, or by manipulating the frame rate itself for 24 to 25 fps for a PAL-compatible display.

U.S. Pat. No. 5,999,220 builds on this technology. According to one aspect, a high-capacity video storage capability with asynchronous recording and reproducing is provided to perform a frame-rate conversion on the input audio/video program. Images may also be re-sized to produce a desired aspect ratio or dimensions using conventional techniques such as pixel interpolation, and signals within the video data stream optionally may be utilized to control “pan/scan” operations at a receiving video display unit, in case this unit does not have the same aspect ratio as the source signal. Other information may be utilized to restrict playback of the program material based on predetermined regional or geographical criteria.

U.S. Pat. No. 6,370,198 extends these capabilities further by providing hardware and associated methods for maintaining the original high bandwidth of conventional cameras (up to 15 MHZ, which corresponds to more than 600 TV-lines of resolution-per picture height for 16:9 aspect ratio), while providing optimized compression techniques to fully utilize the available capacity of general storage media, such as the commercially available Panasonic DVCPRO, DVCPRO50, Sony DVCAM, JVC Digital-S, and Sony Betacam SX recorders. The system preferably employs a consistent compression scheme utilizing only intra-frame compression (such as Motion-JPEG-type systems, systems used in DV-format recorders, MPEG-2 4:2:2P@ML) throughout the entire production process. This avoids many signal artifacts, ensures high signal-to-noise ratios, and provides for editing the program material in data-compressed format. The system also preserves the original camera capability of 600+TV-lines of resolution per picture height, and with 4:2:2 processing provides a chrominance bandwidth of up to 7.5 MHZ. Utilizing 10-bit processing results in 65 dB signal-to-noise performance and improved camera sensitivity (rating of f-11). In contrast, available and proposed systems for HDTV are based on 8-bit processing, and offer performance of less than 54 dB signal-to-noise ratio and camera sensitivity rating of only f-8.

The invention provides for optimization of the available storage media as well. Utilizing hard-disks, optical discs (such as DVD, DVD-R, and DVD-RAM), magneto-optical discs, or digital tapes (such as DAT-format, DVC, DVCPRO, DVCPRO50, DVCAM, Digital-S, or 8-mm format) the data-rate to be recorded is nearly one-quarter that of conventional HDTV systems, and consumes only 20 GB of storage space to record more than 60 minutes in the Production Format compression scheme, which utilizes a data-rate of 50 Mb per second or less, and which is well within the capabilities of certain conventional recording devices. Horizontal and vertical pixel-interpolation techniques are utilized to quadruple the image size, preferably resulting in an image frame size of 1920×1080 pixels. The resulting program information may then be distributed in a conventional compression format, such as MPEG-2.

Three alternative image frame sizes preferably are suggested, depending on the intended application. For general usage, an image frame size of 1024×576 is recommended. As an option, a frame size of either 1280×720 or 1920×1080 may be utilized, at 24 frames-per-second. A sampling frequency of up to 74.25 MHZ for luminance is utilized for 1920×1080. Sampling frequencies of up to 37 MHZ are preferably are utilized for 1024×576 and 1280×720. Chrominance components preferably are sampled consistent with a 4:2:2 system, and 10-bit precision is preferred.

The technology of display devices and methodology has progressed as well, offering alternative features such as conversion of interlaced signals to progressive scan, line doubling, pixel quadrupling, and improved general techniques for horizontal and vertical pixel interpolation. Availability of these features as part of display devices will simplify the process of implementing multi-format digital production.

### SUMMARY OF THE INVENTION

This invention further extends the capabilities discussed in the Background through a variety of improvements in distinct areas. One embodiment addresses the manner in which a frame rate transformation is executed. The transformation is performed so as to simplify the editing and compression of the image signal after the transformation has been performed. For current image compression technology, progressive frames can be processed more efficiently than interlaced frames. In addition, when a 3:2 pull-down sequence is applied to a 24 fps signal in order to produce a 60i signal, the result is that some of the frames (two out of five) will be “mixed”, because each of the two fields is derived from a different film frame. By ensuring that frame-rate transformation results in no mixed frames, editing is simplified and data compression is more efficient.

Yet a further embodiment takes advantage where possible of the hardware configurations disclosed in the parent applications to address the precise manner in which frame-rate transformation is executed. Broadly, the transformation is performed so as to simplify the editing and compression of the image signal after the transformation has been performed.

In general, it is most efficient for every scene of a series of interlaced frames to end with a frame constructed from an odd field and an even field which both are derived from the same film frame, and for the new scene begin with a frame constructed of an odd field and an even field which both are derived from the same film frame.

In order to maximize image compression efficiency and to minimize the complexity of editing, the frames surrounding the selected edit points at a scene change can be buffered, so that the frames can be re-constructed, if necessary, to produce “pure” rather than mixed frames. The frames then are intelligently selected or constructed, using techniques such as field or frame dropping, frame repeating, and so forth, as necessary. This technique may be applied both to the series of frames leading up to an edit point, and also to the series of frames which follow the edit point.

### BRIEF DESCRIPTION OF THE DRAWINGS

FIGS. 1A-1D show the preferred and alternative image aspect ratios in pixels;

FIG. 2 shows a functional diagram for disk/tape-based video recording;

FIG. 3 shows the components comprising the multi-format audio/video production system;

FIG. 4 is a block diagram of an alternative embodiment of video program storage means incorporating asynchronous reading and writing capabilities to carry out frame-rate conversions;

FIG. 5 shows the inter-relationship of the multi-format audio/video production system to many of the various existing and planned video formats;

FIG. 6 shows the implementation of a complete television production system, including signals provided by broadcast sources, satellite receivers, and data-network interfaces;

FIGS. 7A and 7B show the preferred methods for conversion between several of the most common frame-rate choices;

FIGS. 7C-7I show details of possible methods for frame rate conversion processes;

FIG. 7J shows the details of the preferred method of creating a frame-rate-converted signal having no mixed frames from a 24 frame per second original signal;

FIG. 7K shows the details of the preferred method of converting a 60I or 60P signal derived from a 24 frame per second original signal to a 50I or 60P signal having no mixed or interpolated frames;

FIG. 7L shows the details of the preferred method of converting a 50I or 50P signal derived from a 24 frame per second original signal to a 60I or 60P signal having no mixed or interpolated frames;

FIG. 7M shows the details of the preferred method of converting a 60I or 60P to a 50I or 50P signal capable of being edited without errors introduced by mixed frames;

FIG. 7N shows the details of the preferred method of converting a 50I or 50P signal to a 60I or 60P capable of being edited without errors introduced by mixed frames; and

FIG. 8 shows a block diagram of an embodiment of a universal playback device for multi-format use.

### DETAILED DESCRIPTION OF THE INVENTION

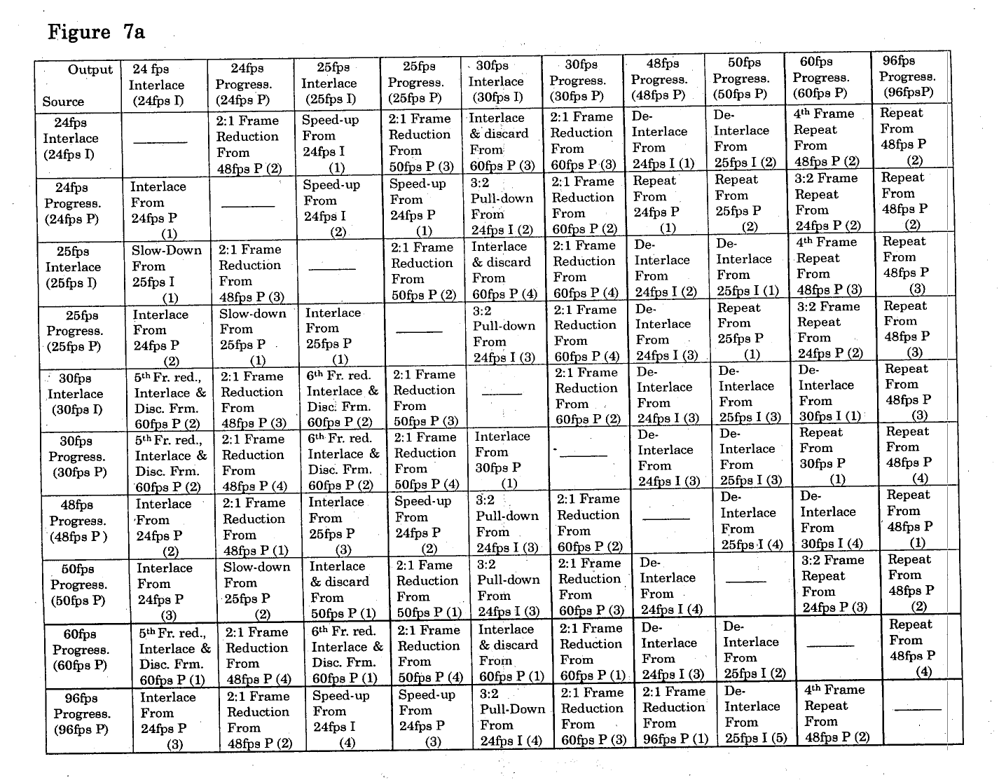

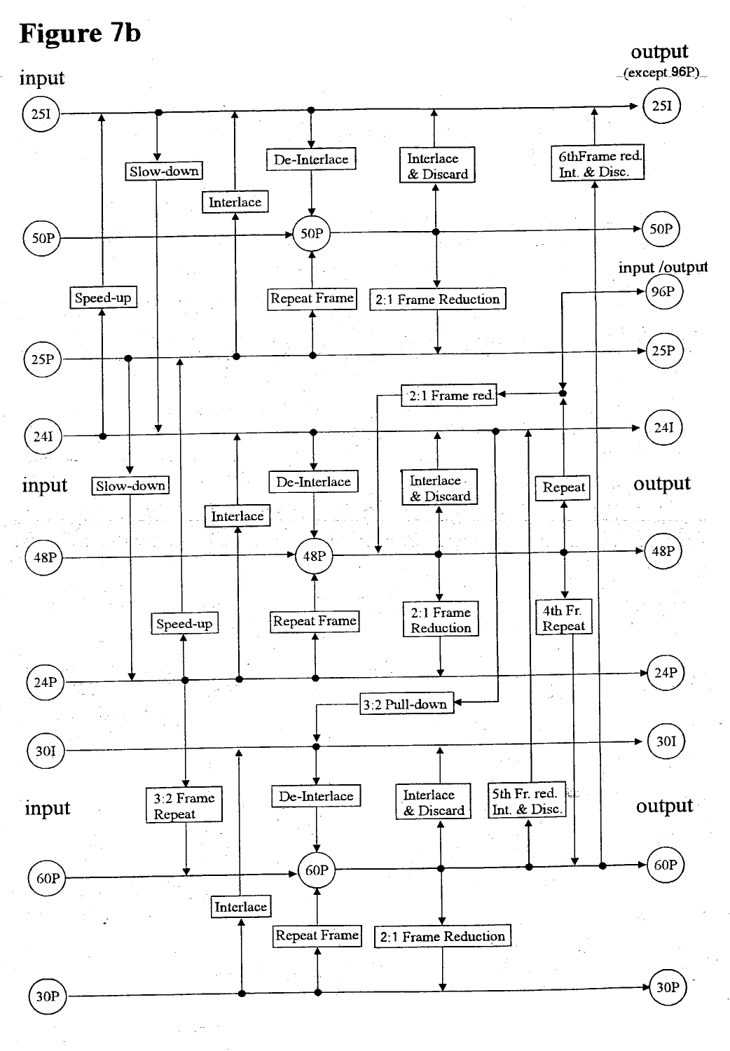

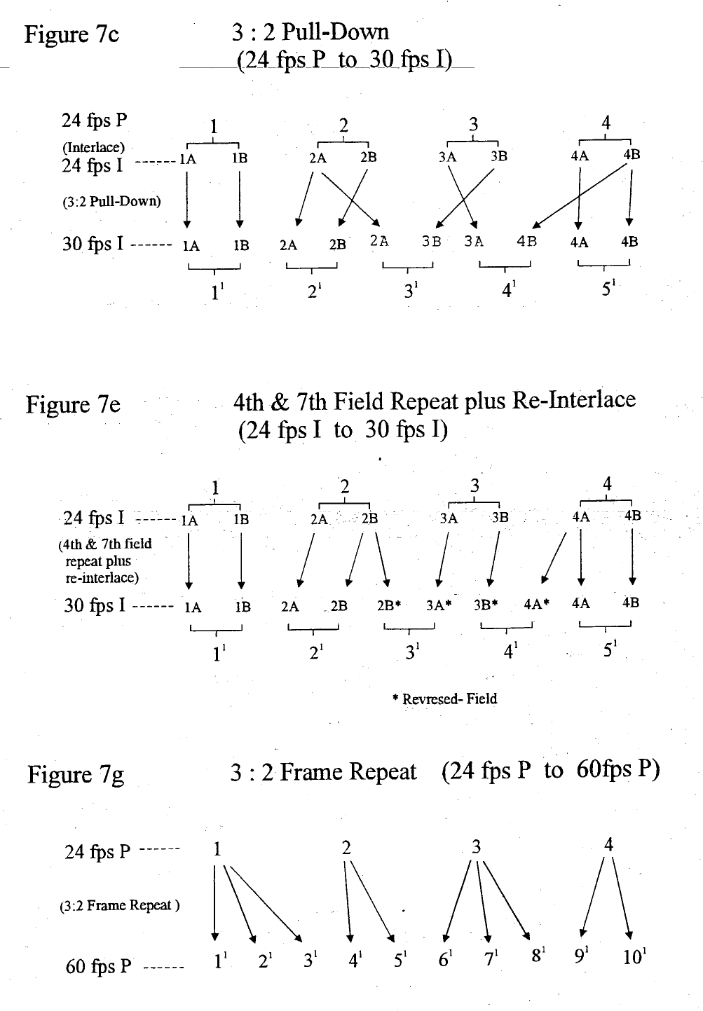

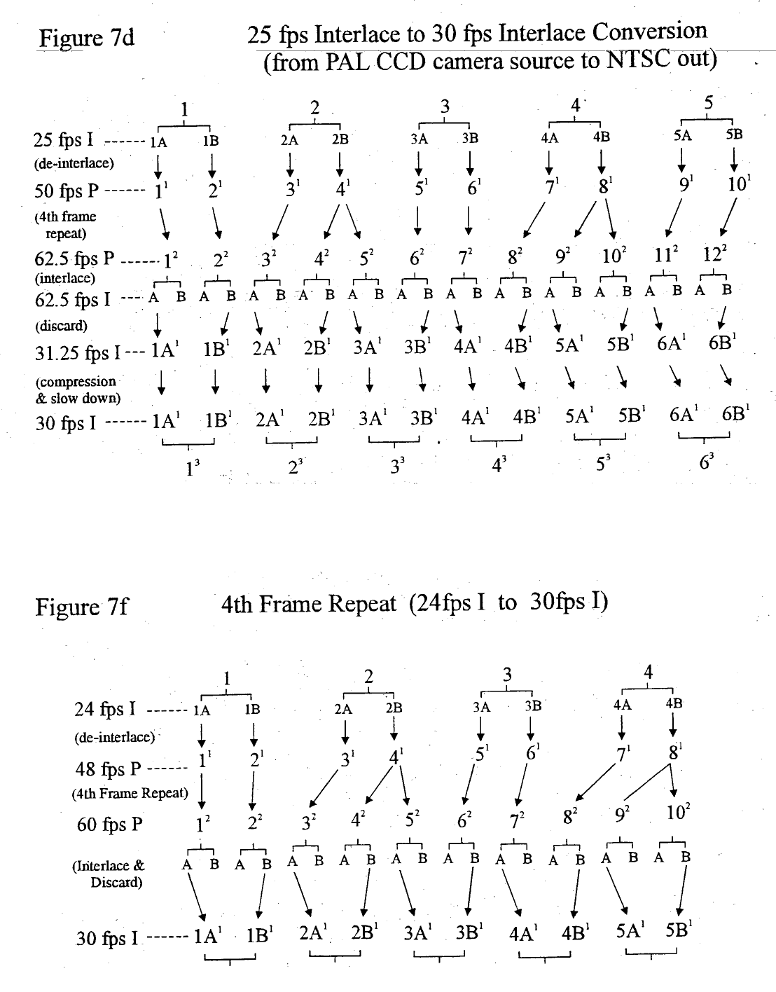

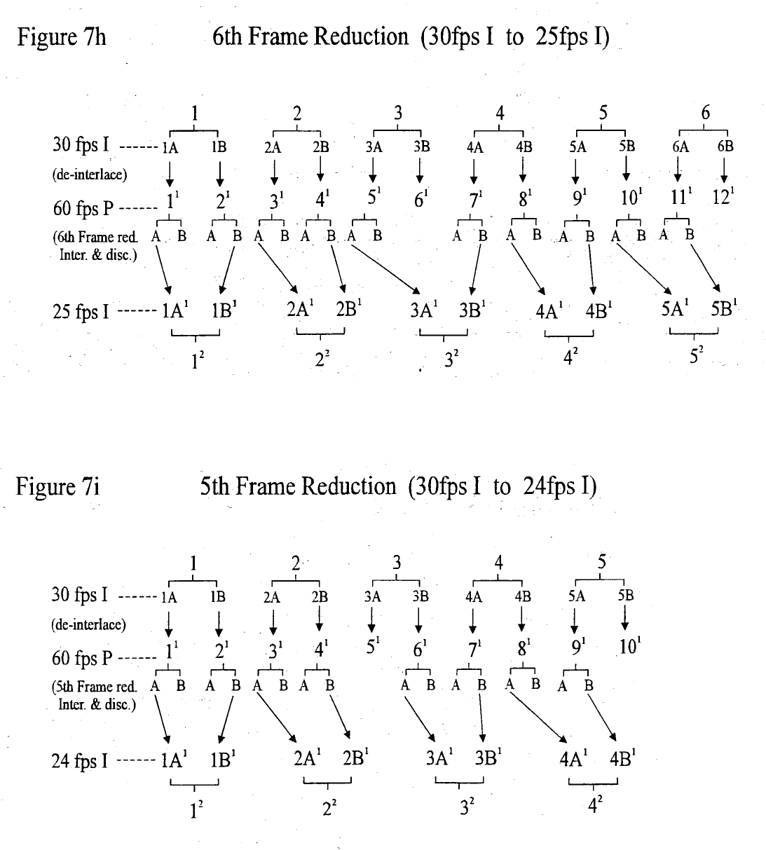

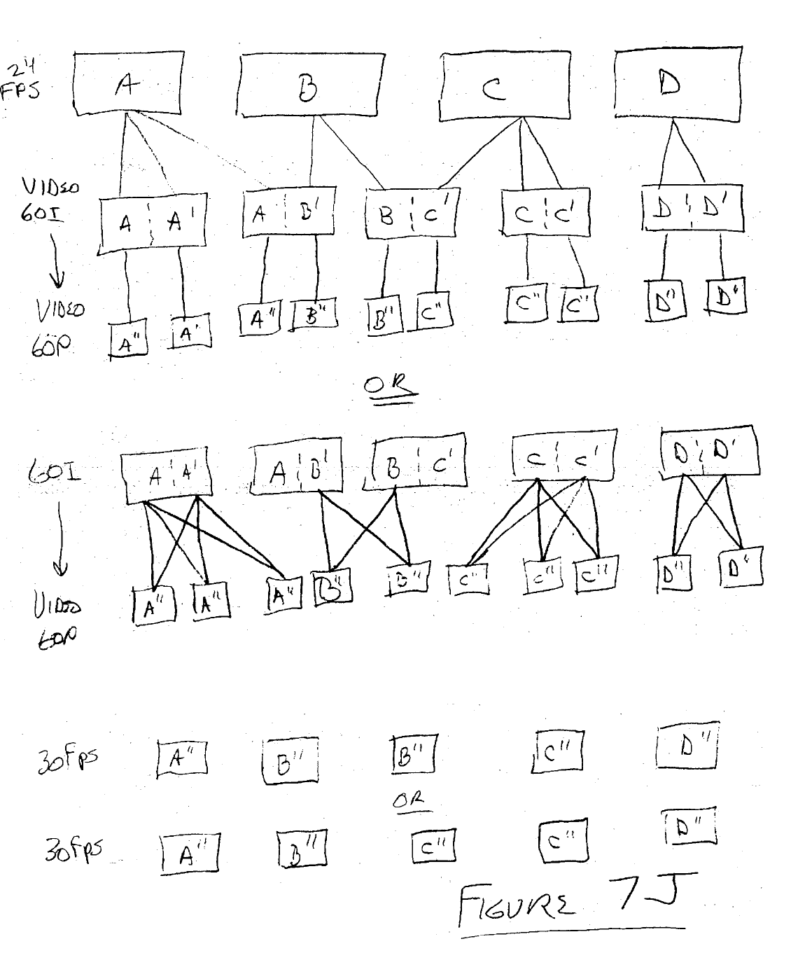

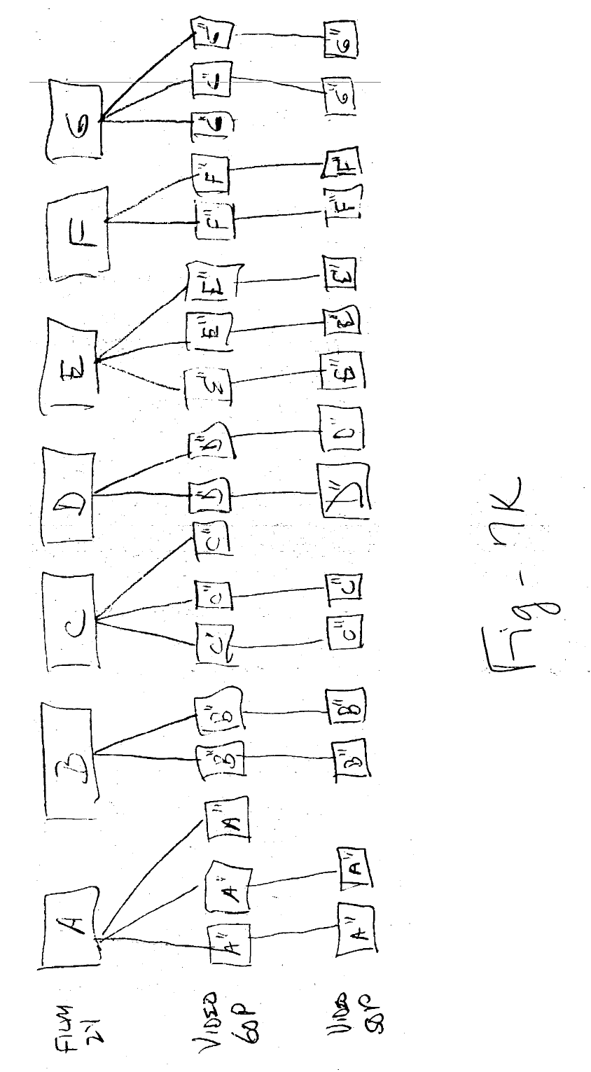

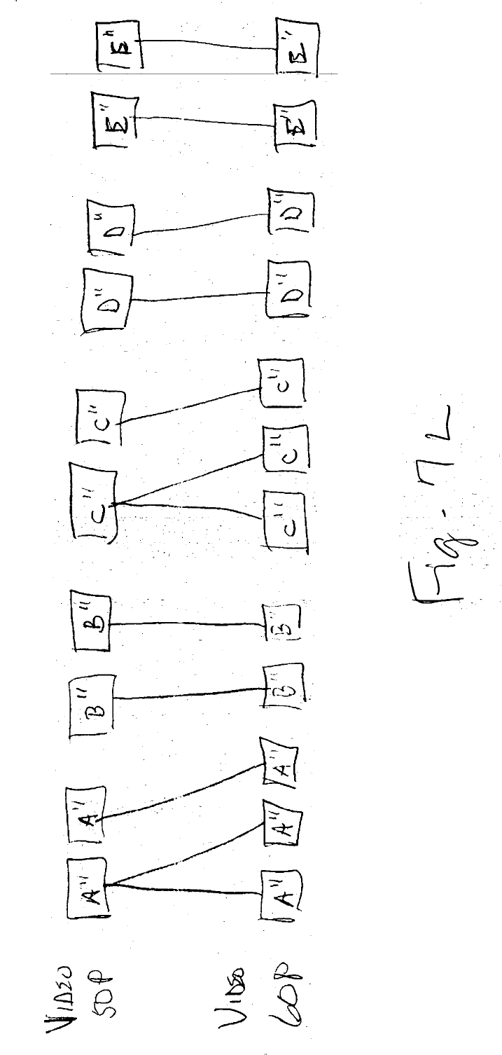

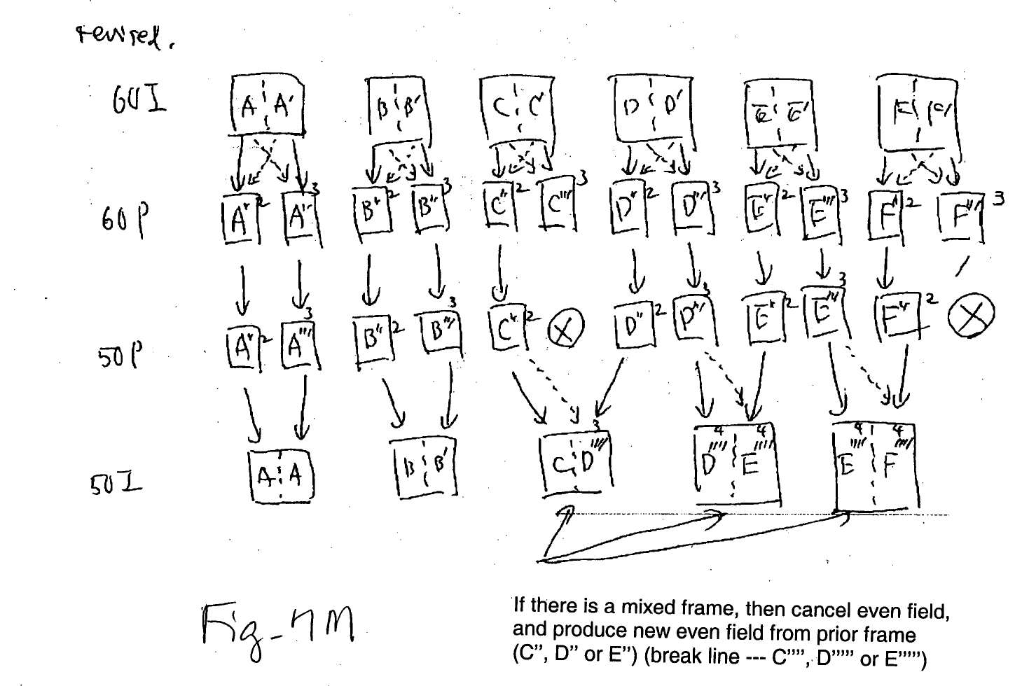

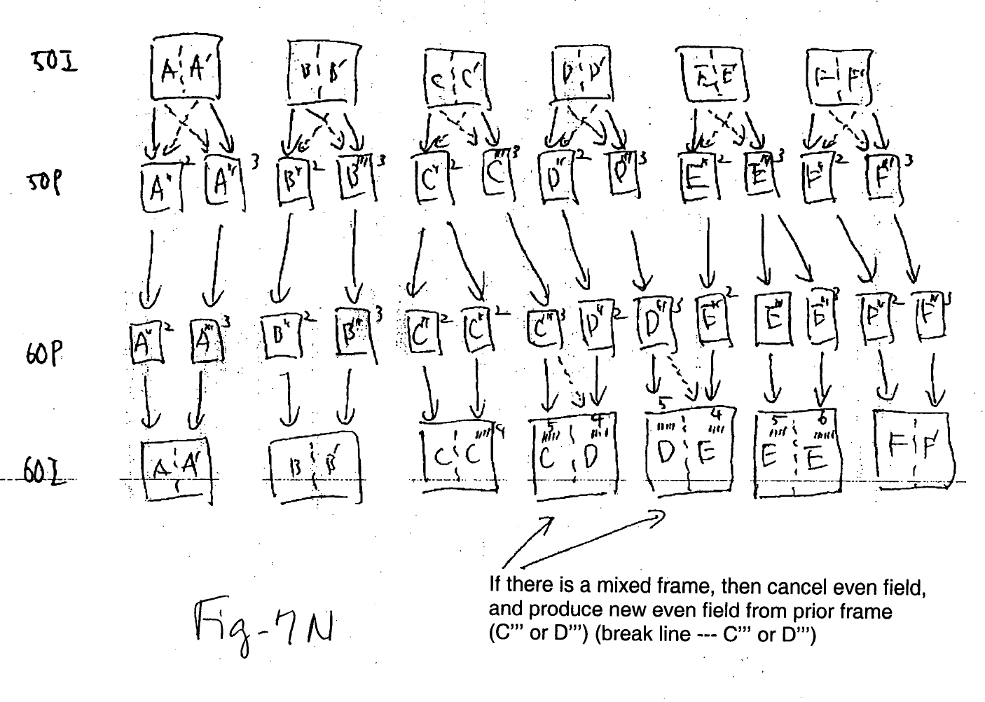

The present invention resides in the conversion of disparate graphics or television formats, including requisite frame-rate conversions, to establish an inter-related family of aspect ratios, resolutions, and frame rates, while remaining compatible with available and future graphics/TV formats, including images of pixel dimensions capable of being displayed on currently available multi-scan computer monitors. Custom hardware is also disclosed whereby frames of higher pixel-count beyond the capabilities of these monitors may be viewed. Images are re-sized by the system to larger or smaller dimensions so as to fill the particular needs of individual applications, and frame rates are adapted by inter-frame interpolation or by traditional schemes such as using “3:2 pull-down” (such as 24 frame-per-second (fps) Progressive to 30 fps interlace shown in FIG. 7C or 48 fps Progressive to 60 fps Progressive, as would be utilized for film-to-NTSC conversions) or by speeding up the frame rate itself (such as for 24 to 25 fps for PAL television display). The resizing operations may involve preservation of the image aspect ratio, or may change the aspect ratio by “cropping” certain areas, by performing non-linear transformations, such as “squeezing” the picture, or by changing the vision center for “panning,” “scanning” and so forth. Inasmuch as film is often referred to as “the universal format,” (primarily because 35-mm film equipment is standardized and used throughout the world), the preferred internal or “production” frame rate is preferably 24 fps. This selection also has an additional benefit, in that the 24 fps rate allows the implementation of cameras having greater sensitivity than at 30 fps, which is even more critical in systems using progressive scanning (for which the rate will be 48 fields per second interlaced (or 24 fps Progressive) vs. 60 fields per second interlaced in some other proposed systems).

The image dimensions chosen allow the use of conventional CCD-type cameras, but the use of digital processing directly through the entire signal chain is preferred, and this is implemented by replacing the typical analog RGB processing circuitry with fully digital circuitry. Production effects may be conducted in whatever image size is appropriate, and then re-sized for recording. Images are recorded by writing the digital data to storage devices employing internal or removable hard-disk drives, disk drives with removable media, optical or magneto-optical based drives, DVD-R or DVD-RAM type drives, tape-based drives, or semiconductor-based memory devices, preferably in compressed-data form.

As data rates for image processing and reading from, or writing to, disk drives increase, many processes that currently require several seconds will soon become attainable in real-time. This will eliminate the need to record film or video frames at slower rates. Other production effects, such as slow-motion or fast-motion may be incorporated, and it is only the frame-processing-rate of these effects that is limited in any way by the technology of the day. In particular, techniques such as non-linear-editing, animation, and special-effects will benefit from the implementation of this system. In terms of audio, the data rate requirements are largely a function of sound quality. The audio signals may be handled separately, as in an “interlocked” or synchronized system for production, or the audio data may be interleaved within the video data stream. The method selected will depend on the type of production manipulations desired, and by the limitations of the current technology.

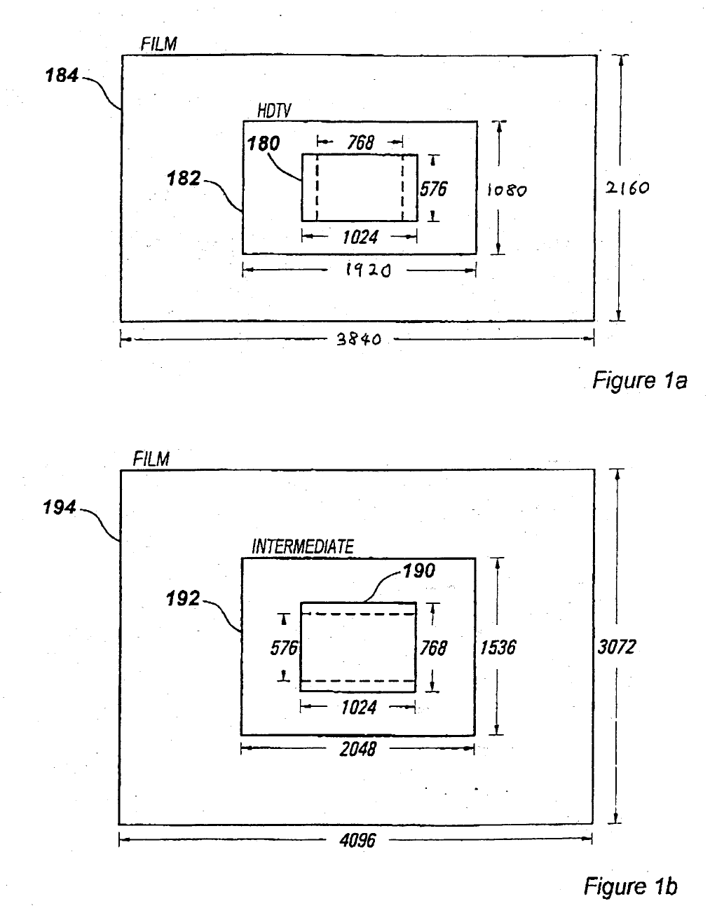

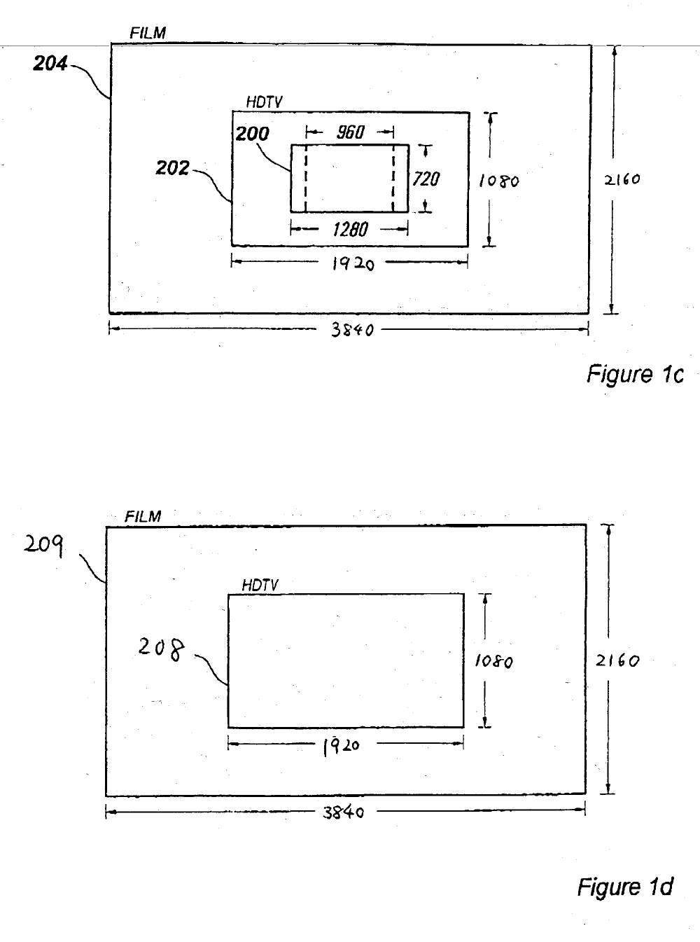

Although a wide variety of video formats and apparatus configurations are applicable to the present invention, the system will be described in terms of the alternatives most compatible with currently available equipment and methods. FIG. 1A illustrates one example of a compatible system of image sizes and pixel dimensions. The selected frame rate is preferably 24 per second progressive (for compatibility with film elements), or 48 fields per second interlaced (for live program material such as sporting events). The selected picture dimension in pixels is preferably 1024×576 (0.5625 Mpxl), for compatibility with the Standard Definition TV (SDTV) 16:9 “widescreen” aspect ratio anticipated for HDTV systems, and the conventional 4:3 aspect ratio used for PAL systems [768×576 (0.421875 Mpxl)] or NTSC systems [640×480 (0.3072 Mpxl)]. All implementations preferably rely on square pixels, though other pixel shapes may be used. Resizing (using the well known, sophisticated sampling techniques available in many image-manipulation software packages or, alternatively, using horizontal and vertical pixel interpolation hardware circuitry described herein below) either to 1280×720 (0.922 Mpxl) or else to 1920×1080 (2.14 Mpxl) provides an image suitable for HDTV displays or even theatrical projection systems, and a further re-sizing to 3840×-2160 (8.3 Mpxl) is appropriate for even the most demanding production effects. Images may be data compressed, preferably 5:1 with Motion-JPEG-type compression such as utilized in DV-format equipment, or preferably 10:1 with MPEG-2 4:2:2P@ML compression.

In order to preserve the full bandwidth of this high-resolution signal, a higher sampling frequency is required for encoding, preferably approximately 20 MHZ, for 1024×576 at 24 fps, which results in 1250 samples per total line, with 625 total lines per frame. This sampling rate allows processing a 10 MHZ bandwidth luminance signal, which corresponds to approximately 600 TV lines of resolution per picture height. In contrast, traditional SDTV digital component systems employ a sampling frequency of 13.5 MHZ, which provides a luminance bandwidth of 5 to 6 MHZ (approximately 300 to 360 TV lines of resolution per picture height. These wideband data files may then be stored on conventional magnetic or optical disk drives, or tape-based storage units, requiring only approximately 5.5 MB/sec for SDTV widescreen frames in Y/R-Y/B-Y (assuming a 4:2:2 system at 8 bits per sample). The resultant data rate for this system is less than 50 Megabits per second, which is within the capabilities of currently available video recording equipment, such as the Betacam SX, DVCPRO50 or Digital S50. If a higher data-compression ratio is applied, then other units may be used, such as DVC, DVCPRO or DVCAM; Betacam SX, DVCPRO50 or Digital S50 may be used to allow sampling to 10-bit precision rather than 8-bit precision.

An alternative aspect of the invention is shown in FIG. 1B. In this case, the user follows a technique commonly used in film production, in which the film is exposed as a 4:3 aspect ratio image. When projected as a widescreen format image, the upper and lower areas of the frame may be blocked by an aperture plate, so that the image shows the desired aspect ratio (typically 1.85:1 or 1.66:1). If the original image format were recorded at 24 frames per second, with a 4:3 ratio and with a dimension in pixels of 1024×768, all image manipulations would preserve these dimensions. Complete compatibility with the existing formats would result, with NTSC and PAL images produced directly from these images by re-scaling, and the aforementioned widescreen images would be provided by excluding 96 rows of pixels from the top of the image and 96 rows of pixels from the bottom of the image, resulting in the 1024×576 image size as disclosed above. The data content of each of these frames would be 0.75 Mpxls, and the data storage requirements disclosed above would be affected accordingly.

Another aspect of the invention is depicted in FIG. 1C. In this alternative, the system would follow the image dimensions suggested in several proposed digital HDTV formats considered by the Advanced Television Study Committee of the Federal Communications Commission. The format adopted assumes a widescreen image having dimensions of 1280×720 pixels. Using these image dimensions (but at 24 fps progressive), compatibility with the existing formats would be available, with NTSC and PAL images derived from this frame size by excluding 160 columns of pixels from each side of the image, thereby resulting in an image having a dimension in pixels of 960×720. This new image would then be re-scaled to produce images having pixel dimensions of 640×480 for NTSC, or 768×576 for PAL. The corresponding widescreen formats would be 854×480 and 1024×576, respectively. Utilizing a 4:2:2 sampling scheme, the 1280×720 image will require 1.85 MB when sampled at a precision of 8-bits, and 2.3 MB when sampled at a precision of 10-bits. When these signals are data-compressed utilizing a compression ratio of 10:1 for recording, the two image sizes require data rates of 4.44 MB per second (35.5 megabits per second) or 5.55 MB per second (44.4 megabits per second).

In order to preserve the full 15 MHZ bandwidth of this high-resolution signal, a sampling frequency of approximately 30 MHZ is required for encoding, which results in 1650 samples per total line, with 750 total lines per frame for a 1280×720 image at 24 frames-per-second. In contrast, typical high definition systems require sampling rates of 74 MHZ to provide a bandwidth of 30 MHZ). In this case, an image having a dimension in pixels of 1280×720 would contain 0.87890625 Mpxl, with 720 TV lines of resolution. Furthermore, the systems under evaluation by the ATSC of the FCC all assume a decimation of the two chrominance signals, with detail of only 640×360 pixels retained. Overall, the data rate for this system, utilizing 4:2:2 sampling with 10-bit precision, is less than 50 megabits per second. This is within the capabilities of currently available video recording equipment, such as Betacam SX, the DVCPRO50 or Digital S50. Because expensive, high data-rate recorders (such as the Toshiba D-6 format, the HDCAM, and D-5 format), are not required for applications utilizing the instant invention, the cost of the equipment and production systems for these applications is drastically reduced. The development path to 24 fps progressive is both well-defined and practical, as is the use of the previously described methods to produce images having a dimension in pixels of 1920×1080.

A third embodiment of the invention is depicted in FIG. 1D. In this alternative, the system would follow the image dimensions suggested in several proposed digital HDTV formats considered by the Advanced Television Study Committee of the Federal Communications Commission. The format adopted assumes a widescreen image having dimensions of 1920×1080 pixels (2.1 megapixels), but at 24 frames-per-second Progressive. Utilizing a 4:2:2 sampling scheme, this 1920×1080 image will require 4.2 MB when sampled at a precision of 8-bits, and 5.2 MB when sampled at a precision of 10-bits. When these signals are data-compressed utilizing a compression ratio of 10:1 for recording, the two image sizes require data rates of 10 MB per second (80 Megabits per second) or 12.5 MB per second (96 megabits per second). In order to preserve the full bandwidth of this high-resolution signal, a sampling frequency of 74.25 MHZ is required for encoding, which results in 2750 samples per total line, with 1125 total lines per frame. In this case, an image having these dimensions would have over 1,200 TV lines of resolution per picture height, representing over 30 MHZ luminance bandwidth. The chrominance bandwidth (as R-Y/B-Y) would be 15 MHZ. In contrast, HDTV with 1920×1080 and 30 fps Interlace only produces 1,000 TV lines (200 lines less than above) of resolution per picture height from same sampling frequency of 74.25 MHZ.

Overall, the data rate for this system, utilizing 4:2:2 sampling with 10-bit precision, is less than 100 Megabits per second. This is within the capabilities of video recording equipment, such as the Panasonic DVCPR0100 or JVC Digital S100, which will be available in the near future. Because expensive, high data-rate recorders (such as the Toshiba D-6 format, the HDCAM, and D-5 format), are not required for applications utilizing the instant invention, the cost of the equipment and production systems for these applications is drastically reduced. These images may be resized into frames as large as 7680×4320, which would allow use of the system for special optical effects, or with other, specialized film formats, such as IMAX and those employing 65 mm. Camera negatives. In addition, conversions processes are available, as described herein below, to produce other HDTV formats (such as 1280×720 Progressive at 24 fps, 1920×1080 Interlaced at 25 fps, 1920×1080 Progressive at 50 fps, 1920×1080 Interlaced at 30 fps, and 1920×1080 Progressive at 60 fps), or to alternative SDTV formats, (such as 1024×576 at 25 fps, 768×576 at 25 fps, 853×480 at 30 fps, or 640×480 at 30 fps).

In each of the cases described herein above, a positioning or image centering signal may be included within the data stream, so as to allow the inclusion of information which may be utilized by the receiving unit or display monitor to perform a “pan/scan” operation, and thereby to optimize the display of a signal having a different aspect ratio than that of the display unit. For example, a program transmitted in a widescreen format would include information indicating the changing position of the image center, so that a conventional (4:3 aspect ratio) display unit would automatically pan (horizontally and/or vertically) to the proper location. For the display of the credits or special panoramic views, the monitor optionally could be switched to a full “letter-box” display, or the image could be centered and resealed to include information corresponding to an intermediate situation, such as halfway between full-height (with cropped sides) and letter-box (full-width, but with blank spaces above and below the image on the display). This positioning/rescaling information would be determined under operator control (as is typical for pan/scan operations when performing film transfers to video) so as to maintain the artistic values of the original material, within the limitations of the intended display format.

Conventional CCD-element cameras produce images of over 900 TV Lines horizontal Luminance (Y) resolution, with a sensitivity of 2,000 lux at f-11, and with a signal-to-noise ratio of 65 dB. However, typical HDTV cameras, at 1,000 TV Lines resolution and with sensitivity ratings of f-8, produce an image with only a 54 dB signal-to-noise ratio, due to the constraints of the wideband analog amplifiers and the smaller physical size of the CCD-pixel-elements. By employing the more conventional CCD-elements in the camera systems of this invention, and by relying upon the computer to create the HDTV-type image by image re-sizing, the improved signal-to-noise ratio is retained. In the practical implementation of cameras conforming to this new design approach, there will be less of a need for extensive lighting provisions, which in turn, means less demand upon the power generators in remote productions, and for AC-power in studio applications.

In CCD-based cameras, it is also a common technique to increase the apparent resolution by mounting the red and blue CCD-elements in registration, but offsetting the green CCD-element by one-half pixel width horizontally and in some application vertically. In this case, picture information is in-phase, but spurious information due to aliasing is out-of-phase. When the three color signals are mixed, the picture information is intact, but most of the alias information will be canceled out. This technique will evidently be less effective when objects are of solid colors, so it is still the usual practice to include low-pass optical filters mounted on each CCD-element to suppress the alias information. In addition, this technique cannot be applied to computer-based graphics, in which the pixel images for each color are always in registration. However, for Y/R-Y/B-Y video, the result of the application of this spatial-shift offset is to raise the apparent Luminance (Y) horizontal resolution to approximately 900 television lines (a 4:3 aspect ratio utilizing 1200 active pixels per line), and the apparent vertical resolution is increased by 50-100+lines.

During the transition period to implement 24 fps recording as a new production standard, conventional 16:9 widescreen-capable CCD cameras (running in 25 or 30 fps Interlaced mode) may be utilized to implement the wideband recording method so as to preserve the inherent wideband capability of these cameras, in accordance with the invention. By abandoning the requirement for square pixels, sampling frequencies of up to 30 MHZ for luminance (15 MHZ for chrominance) preferably are utilized, which frequencies are less than half the typical sampling rate of 74 MHZ utilized for typical HDTV luminance signals in alternative systems. Chrominance components preferably are sampled consistent with a 4:2:2 system. This wideband data stream is then compressed 10:1, utilizing MPEG-2 4:2:2P@ML at 10-bit. The resultant data rate is still less than 50 Megabits per second. With a straightforward modification to increase the data compression rate to 10:1, this signal may be recorded utilizing any of several conventional recording devices, including Panasonic DVCPRO50, JVC Digital-S, and Sony Betacam SX, thereby preserving the wideband signal (up to 800 TV lines of resolution per picture height). By utilizing the appropriate techniques for image resizing and frame rate conversion as described herein, video systems may be supported consistent with 1280×720 60 fps progressive, 1280×720 24 fps Progressive, 1920×1080 25 fps Interlace, 1920×1080 30 fps Interlace, 1920×1080 50 fps progressive, 1920×1080 60 fps progressive, in accordance with the invention.

The availability of hard-disk drives of progressively higher capacity and data transmission rates is allowing successively longer program duration and higher resolution image displays in real-time. At the previously cited data rates, widescreen frames (1024×576 pixel, 24 fps, 4:2:2 process, 8 bits precision and 5:1 compression) would require 330 MB/min, so that currently available 10 GB disk drives will store more than 30 minutes of video. When the anticipated 50 GB disk drives (5.25-inch disks) become available from Seagate within the year, these units will store 150 minutes, or 2½ hours of video. For this application, a data storage unit is provided to facilitate editing and production activities, and it is anticipated that these units would be employed in much the same way as video cassettes are currently used in Betacam SP and other electronic news gathering (ENG) cameras and in video productions. This data storage unit may be implemented by use of a magnetic, optical (such as DVD-R or DVD-RAM) discs, or magneto-optical disk drive with removable storage media, by a removable disk-drive unit, such as those based on the PCMCIA standards, by tape-based storage means, or by semiconductor-based memory. Future advances in storage technology will lead to longer duration program data storage. Alternatively, this storage capacity could be applied to lower ratios of data compression, higher sampling precision (10 bits or more) or higher-pixel-count images, within the limits of the same size media.

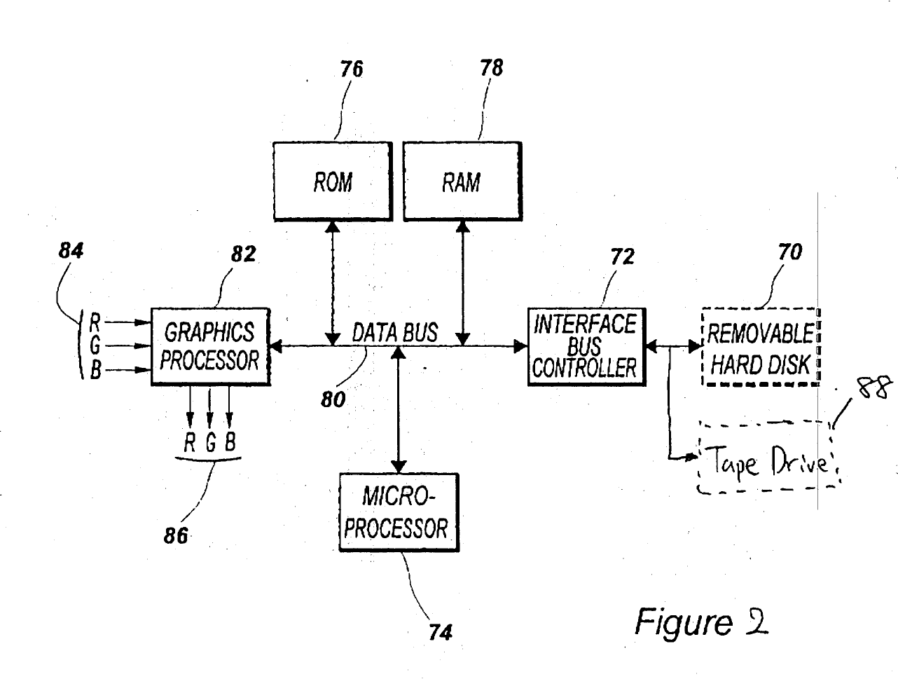

FIG. 2 shows the functional diagram for the storage-device-based digital recorder employed in the video camera, or separately in editing and production facilities. As shown, a removable hard disk drive 70 is interfaced through a bus controller 72. In practice, alternative methods of storage such as optical drives (such as DVD-R or DVD-RAM units) or magneto-optical drives could be used, based on various interface bus standards such as SCSI-2. This disk drive system currently achieves data transfer rates of 40 MB/sec, and higher rates on these or other data storage devices, such as high-capacity removable memory modules, is anticipated. If a digital tape-based format is selected, a tape drive 88 is interfaced through the bus controller 72. Currently available digital tape-based formats include DVCPRO, DVCPRO50, DVCAM, Betacam SX, Digital S50, and others. These units typically offer storage capacities in the range of 30 to 50 GigaBytes. The microprocessor 74 controls the 64-bit or wider data bus 80, which integrates the various components. Currently available microprocessors include the Alpha 21164 by Digital Equipment Corporation, or the MIPS processor family by MIPS Technologies, Inc. Future implementations would rely on the PentiumJ series by Intel Corp. or the PowerPC G3, which is capable of sustained data transfer rates of 100 MB/sec.

Up to 256 MB of ROM, shown at 76, is anticipated for operation, as is 256 MB or more of RAM, shown at 78. Current PC-based video production systems are equipped with at least 64 MB of RAM, to allow sophisticated editing effects. The graphics processor 82 represents dedicated hardware that performs the various manipulations required to process the input video signals 84 and the output video signals 86. Although shown using an RGB format, either the inputs or outputs could be configured in alternative signal formats, such as Y/R-Y/B-Y, YIQ, YUV or other commonly used alternatives. In particular, while a software-based implementation of the processor 82 is possible, a hardware-based implementation is preferred, with the system employing a compression ratio of 5:1 for the conventional/widescreen signals (“NTSC/PAL/Widescreen”), and a 10:1 compression ratio for HDTV signals (1280×720 or 1920×1080, as described herein above). Examples of the many available options for this data compression include the currently available Motion-JPEG system and the MPEG systems. Image re-sizing alternatively may be performed by dedicated microprocessors, such as the gm865X1 or gm833X3 by Genesis Microchip, Inc. Audio signals may be included within the data stream, as proposed in the several systems for digital television transmission considered by the Federal Communications Commission, or by one of the methods available for integrating audio and video signals used in multi-media recording schemes, such as the Microsoft “AVI” (Audio/Video Interleave) file format. As an alternative, an independent system for recording audio signals may be implemented, either by employing separate digital recording provisions controlled by the same system and electronics, or by implementing completely separate equipment external to the camera system described herein above.

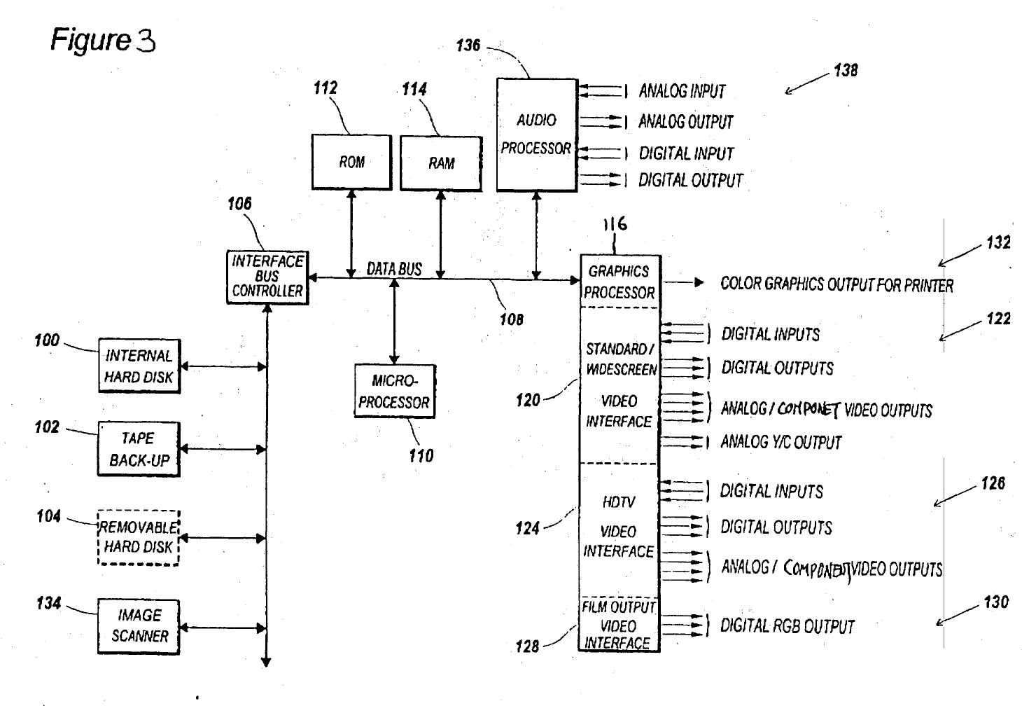

FIG. 3 shows the components that comprise a multi-format audio/video production system according to the invention. As in the case of the computer disk- or tape-based recording system of FIG. 2, an interface bus controller 106 provides access to a variety of storage devices, preferably including an internal hard-disk drive 100, a tape-drive 102, and a hard-disk drive with removable media or a removable hard-disk drive 104. Other possible forms of high-capacity data storage (not shown) utilizing optical, magneto-optical, or magnetic storage techniques may be included, as appropriate for the particular application. The interface bus standards implemented could include, among others, SCSI-2. Data is transmitted to and from these devices under control of microprocessor 110. Currently, data bus 108 would operate as shown as 64-bits wide, employing microprocessors such as those suggested for the computer-disk-based video recorder of FIG. 3. As higher-powered microprocessors become available, such as the PowerPC G3, the data bus may be widened to accommodate 128 bits, and the use of multiple parallel processors may be employed, with the anticipated goal of 1,000 MIPS per processor. Up to 256 MB of ROM 112 is anticipated to support the requisite software, and at least 1,024 MB of RAM 114 will allow for the sophisticated image manipulations, inter-frame interpolation, and intra-frame interpolation necessary for sophisticated production effects, and for conversions between the various image formats.

A key aspect of the system is the versatility of the graphics processor shown generally as 116. Eventually, dedicated hardware will allow the best performance for such operations as image manipulations and re-scaling, but it is not a requirement of the system that it assume these functions, or even that all of these functions be included in the graphics processor in every configuration of the system. Three separate sections are employed to process the three classifications of signals. Although the video input and output signals described herein below are shown, by example, as RGB, any alternative format for video signals, such as Y/R-Y/B-Y, YIQ, YUV, or other alternatives may be employed as part of the preferred embodiment. One possible physical implementation would be to create a separate circuit board for each of the sections as described below, and manufacture these boards so as to be compatible with existing or future PC-based electrical and physical interconnect standards.

A standard/widescreen video interface 120, intended to operate within the 1024×576, 1280×720, 1024×768, 854×480, 640×480 or 1280×960 image sizes, accepts digital RGB or Y/R-Y/B-Y signals for processing and produces digital RGB or Y/R-Y/B-Y outputs in these formats, as shown generally at 122. Conventional internal circuitry comprising D/A converters and associated analog amplifiers are employed to convert the internal images to a second set of outputs, including analog RGB or Y/R-Y/B-Y signals and composite video signals. These outputs may optionally be supplied to either a conventional multi-scan computer video monitor or a conventional video monitor having input provisions for RGB or Y/R-Y/B-Y signals (not shown). A third set of outputs supplies analog Y/C video signals. The graphics processor may be configured to accept or output these signals in the standard NTSC, PAL, or SECAM formats, and may additionally be utilized in other formats as employed in medical imaging or other specialized applications, or for any desired format for computer graphics applications. Conversion of these 24 frame-per-second progressive images to the 30 fps Interlaced (actually, 29.97 fps) NTSC and 25 fps PAL formats may be performed in a similar manner to that used for scanned film materials, that is, to NTSC by using the conventional 3:2 “pull-down” field-sequence, or to PAL by reproducing the images at the higher 25 fps rate.

If the source signal is 24 fps interlaced, these images first are de-interlaced to 48 fps progressive, which can be performed by dedicated microprocessors such as the gmVLD8 or gmVLD10 by Genesis Microchips, and then converted to 60 fps progressive by utilizing a “Fourth Frame Repeat” process (which repeats the fourth frame in every sequence). Next, the signal is interlaced to produced 60 fps interlaced, and half of the fields are discarded to produce 30 fps interlaced (as disclosed in FIG. 7F). If the source format is 25 fps interlaced video (as would result from using conventional PAL-type equipment, or PAL-type equipment as modified in accordance with the invention), the first step is to slow down the frame rate by replaying the signal at 24 fps Interlaced. Next, the signal is de-interlaced to 48 fps progressive (as described herein above), and the Fourth Frame Repeat process is utilized to convert the signal to 60 fps progressive. In the last step, the signal is interlaced to produced 60 fps interlaced, and half of the fields are discarded to produce 30 fps interlaced. Alternatively, if the source signal is 24 fps progressive, the 60 fps progressive signal may be produced directly from a “3:2 Frame Repeat” process shown in FIG. 7G (which is analogous to the conventional “3:2 pull-down” field-sequencing process previously described). For other HDTV frame rates, aspect ratios, and line rates, intra-frame and inter-frame interpolation and image conversions may be performed by employing comparable techniques well known in the art of computer graphics and television.

An HDTV video interface 124, intended to operate within the 1920×1080 or other larger image sizes (with re-sizing as necessary), accepts digital RGB or Y/R-Y/B-Y (or alternative) signals for processing and produces digital outputs in the same image format, as shown generally at 126. As is the case for the standard/widescreen interface 120, conventional internal circuitry comprising DI/A converters and associated analog amplifiers are employed to convert the internal images to a second set of outputs, for analog RGB signals and composite video signals. In alternative embodiments, this function may be performed by an external upconvertor, which will process the wideband signal of the instant invention. A modification of currently available upconvertors is required, to increase the frequency of the sampling clock in order to preserve the full bandwidth of this signal, in accordance with the invention. In this case, frequency of the sampling clock is preferably adjustable to utilize one of several available frequencies.

The third section of the graphics processor 116 shown in FIG. 3 is the film output video interface 128, which comprises a special set of video outputs 130 intended for use with devices such as laser film recorders. These outputs are preferably configured to provide a 3840×2160 or other larger image size from the image sizes employed internally, using re-sizing techniques discussed herein as necessary for the format conversions. Although 24 fps is the standard frame rate for film, some productions employ 30 fps (especially when used with NTSC materials) or 25 fps (especially when used with PAL materials), and these alternative frame rates, as well as alternative image sizes and aspect ratios for internal and output formats, are anticipated as suitable applications of the invention, with “3:2-pull-down” utilized to convert the internal 24 fps program materials to 30 fps, and 25 fps occurring automatically as the film projector runs the 24 fps films at the 25 fps rate utilized for PAL-type materials.

Several additional optional features of this system are disclosed in FIG. 3. The graphics processor preferably also includes a special output 132 for use with a color printer. In order to produce the highest quality prints from the screen display it is necessary to adjust the print resolution to match the image resolution, and this is automatically optimized by the graphics processor for the various image sizes produced by the system. In addition, provisions may be included for an image scanner 134, which may be implemented as a still image scanner or a film scanner, thereby enabling optical images to be integrated into the system. An optional audio processor 136 includes provisions for accepting audio signals in either analog or digital form, and outputting signals in either analog or digital form, as shown in the area generally designated as 138. For materials including audio intermixed with the video signals as described herein above, these signals are routed to the audio processor for editing effects and to provide an interface to other equipment.

It is important to note that although FIG. 3 shows only one set of each type of signal inputs, the system is capable of handling signals simultaneously from a plurality of sources and in a variety of formats. Depending on the performance level desired and the image sizes and frame rates of the signals, the system may be implemented with multiple hard disk or other mass-storage units and bus controllers, and multiple graphics processors, thereby allowing integration of any combination of live camera signals, prerecorded materials, and scanned images. Improved data compression schemes and advances in hardware speed will allow progressively higher frame rates and image sizes to be manipulated in real-time.

Simple playback of signals to produce PAL output is not a serious problem, since any stored video images may be replayed at any frame rate desired, and filmed material displayed at 25 fps is not objectionable. Indeed, this is the standard method for performing film-to-tape transfers used in PAL- and SECAM-television countries. Simultaneous output of both NTSC and film-rate images may be performed by exploiting the 3:2 field-interleaving approach: 5×24=120=2×60. That is, two film frames are spread over five video fields. This makes it possible to concurrently produce film images at 24 fps and video images at 30 fps. The difference between 30 fps and the exact 29.97 fps rate of NTSC may be palliated by slightly modifying the system frame rate to 23.976 fps. This is not noticeable in normal film projection, and is an acceptable deviation from the normal film rate.

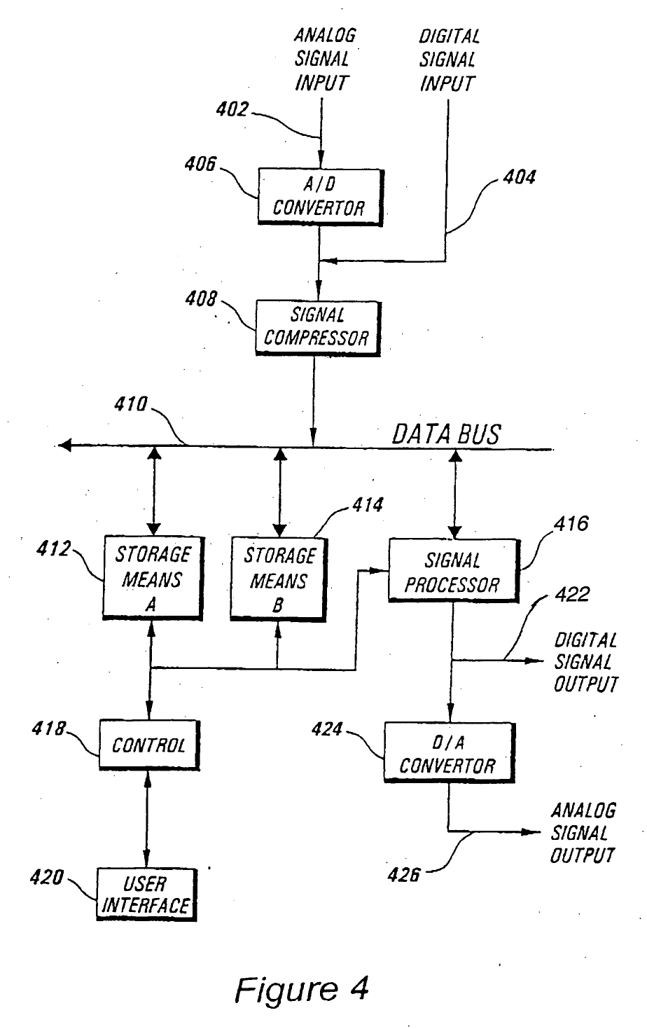

The management of 25 fps (PAL-type) output signals in a signal distribution system configured for 24 fps production applications (or vice versa) presents technical issues which must be addressed, however. One alternative for facilitating these and other frame-rate conversions is explained with reference to FIG. 4. A digital program signal 404 is provided to a signal compression circuit 408. If the input program signal is provided in analog form 402, then it is first processed by A/D converter 406 to be placed in digital form. The signal compressor 408 processes the input program signal so as to reduce the effective data rate, utilizing any of the commonly implemented data compression schemes, such as motion-JPEG, MPEG-1, MPEG-2, etc. well known in the art. As an alternative, the digital program signal 404 may be provided in data-compressed form. At this point, the digital program signal is provided to data bus 410. By way of example, several high-capacity digital storage units, designated as “storage means A” 412 and “storage means B” 414, are included for storing the digital program signals presented on data bus 410, under management by controller 418.

The two storage means 412 and 414 may be used in alternating fashion, with one storing the source signal until it reaches its full capacity. At this point, the other storage means would continue storing the program signal until it, too, reached its full capacity. The maximum program storage capacity for the program signals will be determined by various factors, such as the input program signal frame rate, the frame dimensions in pixels, the data compression rate, the total number and capacities of the various storage means, and so forth. When the available storage capacity has been filled, this data storage scheme automatically will result in previously-recorded signals being overwritten. As additional storage means are added, the capacity for time-delay and frame rate conversion is increased, and there is no requirement that all storage means be of the same type, or of the same capacity. In practice, the storage means would be implemented using any of the commonly available storage techniques, including, for example, magnetic disks, optical (such as DVD-RAM discs) or magneto-optical discs, or semiconductor memory.

When it is desired to begin playback of the program signal, signal processor 416, under management by controller 418 and through user interface 420, retrieves the stored program signals from the various storage means provided, and performs any signal conversions required. For example, if the input program signals were provided at a 25 fps rate (corresponding to a 625-line broadcast system), the signal processor would perform image resizing and inter-frame interpolation to convert the signal to 30 fps (corresponding to a 525-line broadcast system). Other conversions (such as color encoding system conversion from PAL-format to NTSC, etc., or frame dimension or aspect-ratio conversion) will be performed as necessary. The output of the signal processor is then available in digital form as 422, or may be processed further, into analog form 426 by D/A converter 424. In practice, a separate data bus (not shown) may be provided for output signals, and/or the storage means may be implemented by way of dual-access technology, such as dual-port RAM utilized for video-display applications, or multiple-head-access disk or disk storage units, which may be configured to provide simultaneous random-access read and write capabilities. Where single-head storage means are implemented, suitable input buffer and output buffer provisions are included, to allow time for physical repositioning of the record/play head.

In utilizing program storage means including synchronous recording and playback capabilities of the types just described, if it is known that a program will be stored in its entirety before the commencement of playback, that is, with no time-overlap existing between the occurrence of the input and output signal streams, it typically will be most efficient to perform any desired frame conversion on the program either before or after initial storage, depending upon which stored format would result in the least amount of required memory. For example, if the program is input at a rate of 24 frames per second, it probably will be most efficient to receive such a program and store it at that rate, and perform a conversion to higher frame rates upon output. In addition, in situations where a program is recorded in its entirety prior to conversion into a particular output format, it is most efficient to store the program either on a tape-based format or a format such as the new high-capacity DVD-type discs, given the reduced cost, on a per-bit basis, of these types of storage. Of course, conventional high-capacity disk storage also may be used, and may become more practical as storage capacities continue to increase and costs decrease. If it is known that a program is to be output at a different frame rate while it is being input or stored, it is most preferable to use disk storage and to perform the frame rate conversion on an ongoing basis, using one of the techniques described above. In this case, the high-capacity video storage means, in effect, assumes the role of a large video buffer providing the fastest practical access time. Again, other memory means (types) may be used, including all solid-state and semiconductor types, depending upon economic considerations, and so forth.

As an example of an alternative embodiment, the storage means 100 or 104 are equipped with dual-head playback facilities and a second set of graphics processing hardware (not shown) analogous in function to the normal graphics processing hardware (identical to the standard hardware shown as 120, 124, and 128), and having analogous signal output facilities (identical to the standard provisions shown as 122, 126, 130, and 132). In this case, the two heads would be driven independently, to provide simultaneous, asynchronous playback at different frame rates. That is, one head would be manipulated so as to provide a data stream corresponding to a first frame rate (for example, 25 fps), while the second head would be manipulated so as to provide a data stream corresponding to a second frame rate (for example, 24 fps, which, in turn, may be converted to 30 fps, using the “3:2-pull-down” technique). In this case, both the storage means and also the internal bus structure of the system would have to support the significantly increased data rate for providing both signal streams simultaneously, or, as an alternative, a second, separate data bus would be provided.

In some applications, a more sophisticated conversion scheme is required. For example, in frame rate conversion systems of conventional design, if an input program signal having a 24 fps rate format is to be displayed at a 25 fps rate, it is customary to simply speed up the source signal playback, so as to provide the signals at a 25 fps rate. This is the procedure utilized for performing a conversion of 24-fps-film-material for 25 fps PAL-format video usage. However, implementation of this method requires that the user of the output signal must have control over the source-signal playback. In a wide-area distribution system (such as direct-broadcast-satellite distribution) this is not possible. While a source signal distributed at 24 fps readily could be converted to 30 fps (utilizing the familiar “3-2-pull-down” technique), the conversion to 25 fps is not as easily performed, due to the complexity and expense of processing circuitry required for inter-frame interpolation over a 24-frame sequence. However, utilizing the system disclosed in FIG. 4, the conversion is straightforward. If, for example, a 24 fps program lasting 120 minutes is transmitted in this format, there are a total of 172,800 frames of information (24 frames/second×60 seconds/minute×120 minutes). Display of this program in speeded-up fashion at 25 fps would mean that the input frame rate falls behind the output frame rate by one frame per second, or a total of 7,200 frames during the course of the program. At a 24 fps transmission rate, this corresponds to 300 seconds transmission time. In other words, for the input program (at 24 fps) and the output program (at 25 fps) to end together, the input process would have to commence 300 seconds before the output process begins. In order to perform this process, then, it is necessary for the storage means to have the capacity to retain 300 seconds of program material, in effect serving as a signal buffer. As an example, for the systems disclosed herein in which the compressed-data rates range from 5.5 MB/sec (for 24 fps standard/widescreen Y/R-Y/B-Y-based TV formats, using 5:1 data compression such as MPEG or motion-JPEG and 4:2:2 processing with 8-bit precision) to 10 MB/sec (for 24 fps HDTV Y/R-Y/B-Y-based formats, using 10:1 data compression such as MPEG or motion-JPEG and 4:2:2 processing with 8-bit precision), it may be necessary to store as much as 3.3 GBytes of data, which is readily available by way of multiple disks or discs utilizing conventional storage technology. In practice, the transmission simply would begin 300 seconds before the playback begins, and once the playback starts, the amount of buffered signal would decrease by one frame per second of playback until the last signal is passed through as soon as it is received.

A mirror of this situation arises in the case of a 25 fps signal to be displayed at 24 fps, or some other data rate readily provided by conversion from 24 fps (such as 30 fps). In this case, the source signal is provided at a higher frame rate than the output signal, so that a viewer watching a program from the onset of the transmission would fall behind the source signal rate, and the storage means would be required to hold frames of the program to be displayed at a time after the source signal arrival time. In the case of the 120 minute program described above, the viewing of the source program would conclude 300 seconds after the source signal itself had concluded, and comparable calculations are applied for the storage means. In this case, the extra frames would be accumulated as the buffer contents increased, until, after the transmission has completed, the last 300 seconds would be replayed directly from the storage means.

The conversion of frame rates from 30 fps to 24 fps or to 25 fps is more complicated, because some form of inter-frame interpolation is required. In one case, a multi-frame storage facility would allow this type of interpolation to be performed in a relatively conventional manner, as typically is utilized in NTSC-to-PAL conversions (30 fps to 25 fps). At this point, a 25 fps to 24 fps conversion could be performed, in accordance with the methods and apparatus described herein above.

It should be noted that if, for example, a DVD-R-type, DVD-RAM-type, or some form of removable magnetic storage media is selected, then the implementation of the significantly higher data compression rates of MPEG-2 coding techniques will result in the ability to record an entire program of 120 minutes or more in duration. In this manner, the complete program is held in the disk/buffer, thereby enabling the user to perform true time-shifting of the program, or allowing the program rights owner to accomplish one form of software distribution, in accordance with the invention.

An alternative method to carry out this frame rate conversion is carried out utilizing the following process. The 30 fps interlaced signal is first de-interlaced to 60 fps Progressive. Then, every fifth frame is deleted from the sequence, producing a 48 fps progressive signal stream. Next, these remaining frames are converted to 24 fps interlaced, as disclosed in FIG. 7I (“5^{th} Frame Reduction”). If the original source material were from 24 fps (for example, film), then if the repeated fields (i.e., the “3” field of the 3:2 sequence) were identified at the time of conversion, then the removal of these fields would simply return the material to its original form. If the desired conversion is to be from 30 fps to 25 fps, then an equivalent procedure would be performed using the storage-based frame-conversion method described herein above. As an alternative, the 30 fps interlaced signal would first be de-interlaced to 60 fps progressive; then, every sixth frame would be deleted from the sequence (“6^{th} Frame Reduction”). The remaining frames are re-interlaced to produce 25 fps interlaced, as disclosed in FIG. 7H. Depending on the original source material frame rate and intermediate conversions, the user would select the method likely to present the least amount of image impairment.

In the case in which the user is able to exercise control over the frame rate of the source program material, an alternative method is available. Just as film-to-video transfers for PAL-format (25 fps) presentations utilize a speeded-up playback of the 24 fps film materials to source them at the 25 fps Progressive rate (thereby matching the intended output frame rate), the reverse of this process enables a user to utilize materials originated at 25 fps Progressive to produce playback at 24 fps. As disclosed herein above, conversions of 24 fps progressive materials are handled easily by way of conventional methods (such as the “3:2-pull-down” method), and therefore the operator control of the source material enables the user to utilize materials originating from conventional or widescreen PAL format sources for editing and production, then replay the resulting program at 24 fps for conversion to either standard or widescreen NTSC output materials, or even to HDTV format materials, all at 30 fps Interlaced, by performing the “3:2-pull-down” process.

If the source format is 25 fps interlaced video (as would result from using conventional PAL-type CCD widescreen camera), an alternative method for producing a 30 fps Interlaced signal is available. Instead of performing a slow-down to produce a 24 fps interlaced signal, the 25 fps Interlaced signal is first de-interlaced to 50 fps progressive. Next, a “4^{th} Frame Repeat” process is applied, which results in a 62.5 fps progressive signal. This signal is then converted to 62.5 fps interlaced, and after half of the fields are discarded, to produce 31.25 fps interlaced. After data compression, the signal undergoes a slow-down process, resulting in a 30 fps interlaced signal which now has a compressed-data-rate of less than 10 Mbytes per second, as disclosed in FIG. 7D. By using this procedure, the entire process from the CCD camera to the final conversion to 30 fps Interlaced only one data compression step is employed. Alternatively, if the output of the camera is already in data compressed form, then this signal must be decompressed before applying the listed conversion steps. In order to ensure accurate conversion, interlace and de-interlace processes should only be applied to de-compressed signals. Conversely, speed-up and slow-sown procedures are preferably applied with compressed data, as the raw data rate for uncompressed video, depending on the image dimensions in pixels and frame rate, will be in the range of 30 to 100 MB per second, which is not practical for current technology storage devices.

A variety of conversions between formats (both interlaced and progressive) having differing frame rates, and some of these possible conversion paths are indicated in FIGS. 7A through 7I. While extensive, these listings are not intended to represent a complete listing of all alternatives, as in many cases there is more than one combination of methods which may effect an equivalent conversion. Depending on the particular application, different paths may be selected, and these differing paths may produce more, or less, effective results.

The various alternatives utilize several techniques not previously applied to these types of conversions. For example, conversions of 60 fps progressive signals to 30 fps Progressive may be effected by simply dropping alternate frames. On the other hand, a “3:2 Frame Repetition” method consists of repeating a first frame a second and a third time, then repeating the next frame a second time, thereby converting two frames into five frames (as depicted in FIG. 7G).

Depending on whether the source material is 24 fps progressive or 24 fps interlaced, different approaches are utilized for conversion to 30 fps interlaced. In the first case, the 24 fps progressive signal is first converted to 24 fps Interlaced. A set of four consecutive frames may be indicated as 1A1B, 2A2B, 3A3B, 4A4B. By recombining these fields (but outputting them at a 30 fps rate) the following field sequence is obtained: 1A1B, 1A2B, 2A3B, 3A4B, 4A4B. This sequence repeats for every four input frames, which is to say, for every five output frames (as depicted in FIG. 7C).

Alternatively, for a signal which originates at 24 fps Interlaced, the original four-frame sequence is identical. However, the situation is more complicated because the absolute time-sequence of frames must be preserved. For this reason, it is necessary to reverse the field identification of alternate groups of fields in order to preserve the proper interlace relationship between the fields. In effect, every fourth and seventh field in the eight-field (24 fps interlaced) sequence is repeated, but with reversed field identification (as disclosed in FIG. 7E). When the fourth input field has had its identification reversed (to produce the fifth output field), then the next two input fields (corresponding to the sixth and seventh output field) in the sequence also will require field reversal, in order to preserve the correct sequence for proper interlace. Furthermore, when the seventh input field is repeated, the first time it will appear in reversed-field-identity from as the eighth output field. For this procedure, the resulting field sequence will be 1A1B, 2A2B, 2B*3A*, 3B*4A*, 4A4B (wherein a field having reversed field identification is denoted by a * symbol). This sequence repeats for every four input frames, which is to say, for every five output frames.

In addition, the reversal of the field identity of the fourth input field (when repeated) results in information that previously was displayed on the second scan line now being displayed on the first scan line. Therefore, it is necessary to discard the first line of the next reversed-field, so that the information displayed on the second scan line of the new field will be the information previously displayed on the third line of the next (reversed) field. After the seventh input field has been reversed (to produce the eighth output field, the following fields are once again in the proper line order without any further adjustments of this kind (as disclosed in FIG. 7E).

For image manipulations entirely within the internal storage format, there is no issue as to interlacing, as the graphics processor is only manipulating a rectangular array of image pixels, not individual scan lines. As such, identification of fields is derived solely from the location of the image pixels on either odd-numbered lines or even-numbered lines. The interlacing field identification adjustments are made only at the time of output to the display device. In these applications, the presence of the storage means allows the viewer to control the presentation of a program, utilizing a user interface 420 to control the playback delay and other characteristics of the signal while it is being stored or thereafter. In practice, a wide range of alternatives for input frame rates and output frame rate conversions are made available through this system, by selecting the most appropriate of the various methods for altering the frame rate of a signal described herein.

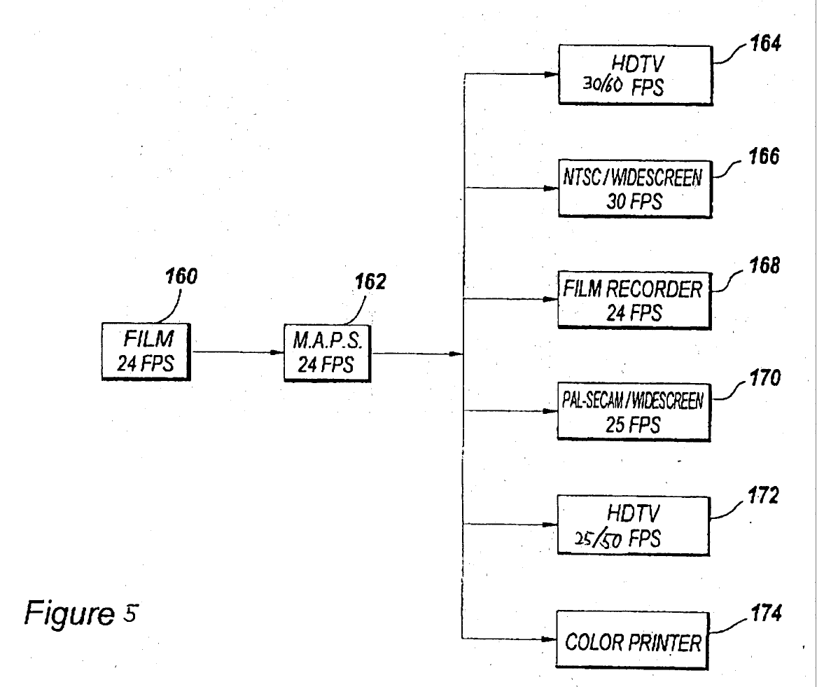

FIG. 5 shows the inter-relationship of the various film and video formats compatible with the invention, though not intended to be inclusive of all possible implementations. In typical operations, the multi-format audio/video production system 162 would receive film-based elements 160 and combine them with locally produced materials already in the preferred internal format of 24 frames-per-second. In practice, materials may be converted from any other format including video at any frame rate or standard. After the production effects have been performed, the output signals may be configured for any use required, including, but not limited to, HDTV at 30/60 fps shown as 164, widescreen at 30 fps shown as 166, widescreen at 25 fps shown as 170, or HDTV at 25/50 fps shown as 172. In addition, output signals at 24 fps are available for use in a film-recording unit 168.

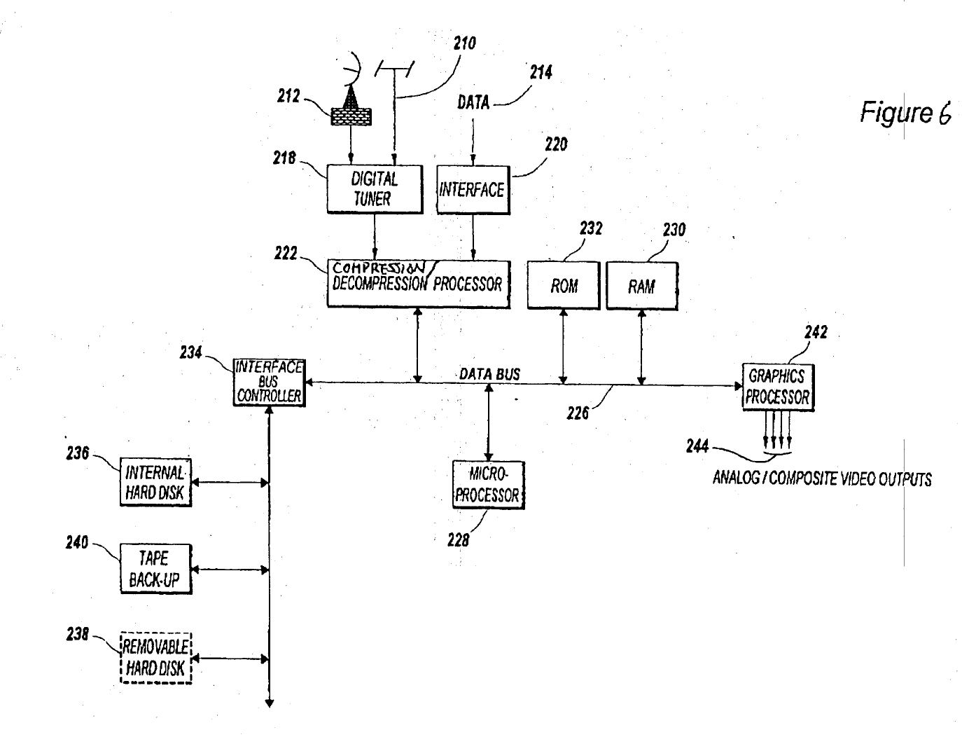

In FIG. 6, signals are provided from any of several sources, including conventional broadcast signals 210, satellite receivers 212, and interfaces to a high bandwidth data network 214. These signals would be provided to the digital tuner 218 and an appropriate adapter unit 220 for access to a high-speed data network before being supplied to the decompression processor 222. As an option, additional provisions for data compression would provide for transmission of signals from the local system to the high bandwidth data network 214. The processor 222 provides any necessary data de-compression and signal conditioning for the various signal sources, and preferably is implemented as a plug-in circuit board for a general-purpose computer, though the digital tuner 218 and the adapter 220 optionally may be included as part of the existing hardware.

The output of processor 222 is provided to the internal data bus 226. The system microprocessor 228 controls the data bus, and is provided with 32 to 128 MB of RAM 230 and up to 64 Mb of ROM 232. This microprocessor could be implemented using one of the units previously described, such as the PowerPC 604, PowerPC G3, Pentium-series, or other processors. A hard disk drive controller 234 provides access to various storage means, including, for example, an internal hard disk drive unit 236, a removable hard disk drive unit 238, a unit utilizing removable magnetic, optical, or magneto-optical media (not shown), or a tape drive 240. These storage units also enable the PC to function as a video recorder, as described above. A graphic processor 242, comprising dedicated hardware which optionally be implemented as a separate plug-in circuit board, performs the image manipulations required to convert between the various frame sizes (in pixels), aspect ratios, and frame rates. This graphics processor uses 16 to 32 MB of DRAM, and 2 to 8 MB of VRAM, depending on the type of display output desired. For frame size of 1280×720 with an aspect ratio 16:9, the lower range of DRAM and VRAM will be sufficient, but for a frame size of 1920×1080, the higher range of DRAM and VRAM is required. In general, the 1280×720 size is sufficient for conventional “multi-sync” computer display screens up to 20 inches, and the 1920×1080 size is appropriate for conventional “multi-sync” computer display screens up to 35 inches. Analog video outputs 244 are available for these various display units. Using this system, various formats may be displayed, including (for 25 fps, shown by speeding up 24 fps signals) 768×576 PAUSECAM, 1024×576 widescreen, and 1280×720/1920×1080 HDTV, and (for 30 and 60 fps, shown by utilizing the well-known “3:2 pull-down” technique, and for 29.97 fps, shown by a slight slow-down in 30 fps signals) 640×480 NTSC and 854×480 widescreen, and 1920×1080 NHK (Japan) HDTV.

It will be appreciated by the skilled practitioner that most of the highest quality program material has been originated on 24 fps 35-mm film, and therefore conversions that rely on reconstituting the signal material from 25 fps or 30 fps materials into 24 fps material do not entail any loss of data or program material. In addition, signals that have been interlaced from a lower or equivalent frame rate source signal in any of the currently available means (24 fps to 25 fps via speed-up; 24 fps to 30 fps via “3:2-pull-down”) may be de-interlaced and reconstituted as progressive-scan frames without introducing any signal artifacts, provided that the original frames are recreated from properly matched fields. If it is desired to produce 24 fps interlaced, 25 fps Interlaced, or 30 fps interlaced signals from higher frame rate progressive signals (such as 48 fps Progressive, 50 fps progressive, or 60 fps progressive signals, respectively), these may be obtained by interlacing these signals and discarding the redundant data. Alternatively, if it is desired to produce 24 fps progressive, 25 fps progressive, 30 fps Progressive, or 48 fps progressive signals from higher frame rate progressive signals (such as 48 fps progressive, 50 fps progressive, 60 fps progressive, or 96 fps progressive signals, respectively), these may be obtained by applying a 2:1 frame reduction. These techniques are summarized in FIG. 7A, with conversion charts showing typical process flow charts in FIGS. 7B and 7C.

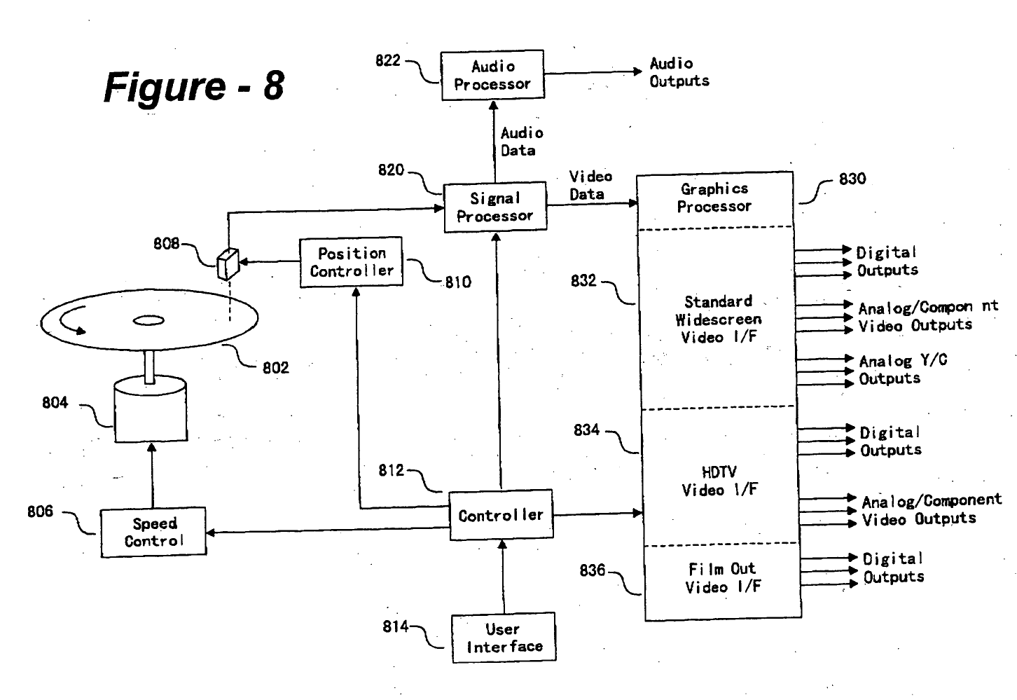

FIG. 8 shows one possible implementation of a universal playback device, in accordance with the invention. By way of example, a DVD-type video disk 802 is rotatably driven by motor 804 under control of speed-control unit 806. One or more laser read- or read/write-heads 808 are positioned by position control unit 810. Both the speed control unit and the position control unit are directed by the overall system controller 812, at the direction of the user interface 814. It should be noted that the number and configuration of read- or read/write-heads will be determined by the choice of the techniques employed in the various embodiments disclosed herein above. The signal recovered from the laser heads is delivered to signal processor unit 820, and the data stream is split into an audio data stream (supplied to audio processor unit 822) and a video data stream (supplied to video graphics processor unit 830). During the audio recovery process, the alteration of the playback frame rate (for example, from 24 fps to 25 fps, accomplished by speed control adjustment) may suggest the need for pitch-correction of the audio material. This procedure, if desired, may be implemented either as part of the audio processor 822, or within a separate, external unit (not shown), as offered by a number of suppliers, such as Lexicon.

The video data stream may undergo a number of modifications within the graphics processor, shown generally at 830, depending on the desired final output format. Assuming that the output desired is NTSC or some other form of widescreen or HDTV signal output at a nominal frame rate of 30 fps, a signal sourced from the disk at 24 fps would undergo a “3:2-pull-down” modification as part of the conversion process (as explained herein above). If the signal as sourced from the disk is based on 25 fps, then it would undergo an preliminary slowdown to 24 fps before the “3:2-pull-down” processing is applied. It should be noted that the 0.1% difference between 30 fps and 29.97 fps only requires the buffering of 173 frames of video over the course of a 120-minute program, and at a data rate of 5.5 MB/sec, this corresponds to approximately 39 MB of storage (for standard/widescreen) or 79 MB of storage (for HDTV), which readily may be implemented in semiconductor-based memory. In any event, a signal supplied to the graphics processor at a nominal 24 fps simultaneously may be output at both 30 fps and 29.97 fps, in image frames compatible with both NTSC and NTSC/widescreen (the standard/widescreen video interface 832), and HDTV (HDTV video interface 834), in accordance with the invention as described herein above.

As disclosed above, an optional film output video interface 836 may be included, with digital video outputs for a film recorder. Overall, the outputs for the graphics processor 830 parallel those of the Multi-Format Audio/Video Production System as shown in FIG. 5 and disclosed herein above. In addition, for signals to be output in a format having a different aspect ratio than that of the source signal, it may be necessary to perform a horizontal and/or vertical “pan/scan” function in order to assure that the center of action in the source program material is presented within the scope of the output frame. This function may be implemented within the graphics processor by utilizing a “tracking” signal associated with the source program material, for example, as part of the data stream for each frame, or, alternatively, through a listing identifying changes that should be applied during the presentation of the source material. Where no “tracking” information is available, the image frame would be trimmed along the top and bottom, or the sides, as necessary in order to fit the aspect ratio of the source material to the aspect ratio of the output frame. This latter technique is explained herein above, with reference to FIGS. 1A-1D. In addition, the program material may include security information, such as regional or geographical information directed towards controlling the viewing of the program material within certain marketing areas or identifiable classes of equipment (such as hardware sold only in the United States or in the German market). This information, as has been disclosed for use with other disk- and tape-based systems, often relates to issues such as legal licensing agreements for software materials. It may be processed in a way similar to the detection and application of the “pan/scan” tracking signal, and the signal processor 820, under the direction of controller 812 may act to enforce these restrictions.

Alternatively, if output at 25 fps is desired, it is a simple matter to configure the various components of this system to replay the video information of the disk 802 at this higher frame rate. The controller will configure the speed control unit 806 (if necessary) to drive the motor 804 at a greater rotational speed to sustain the increased data rate associated with the higher frame rate. The audio processor 822, if so equipped, will be configured to correct for the change in pitch associated with the higher frame rate, and the graphics processor will be configured to provide all output signals at the 25 fps frame rate. As Alternate method for audio pitch correction, additional audio data can be stored in disk which is already corrected. When the frame rate is changed, the corresponding audio data is selected in accordance with the invention.

As yet another alternative, materials produced at 25 fps and stored on the disk-based mass storage means of this example could originate from conventional standard or widescreen PAL format signals. Utilizing the slow-down method, these signals are readily converted to 24 fps frame rate, from which conversion to various 30 fps formats is implemented, as disclosed herein above. This feature has significance in the commercial development of HDTV, as the ability to utilize more-or-less conventional PAL format equipment greatly facilitates the economical production and origination of materials intended for HDTV markets.

A wide range of output frame rates may be made available through combination of the techniques of speed-up, slow-down, “3-2-pull-down,” and other related field-rearrangement, de-interlacing, interlacing/de-interlacing, frame repetition, and frame reduction techniques, as disclosed herein above with respect to FIG. 4 and FIGS. 7A-7E, and these various combinations and approaches should be considered to be within the scope of the invention. In addition, these techniques may be combined with hardware and/or software which perform image manipulations such as line-doubling, line-quadrupling, deinterlacing, etc., such that the display device will be capable of providing smoother apparent motion, by increasing the display rate without increasing the actual data/information rate. One example would be to process the 24 fps signal from the internal format to convert it into a 48 fps signal, using field-doubling techniques such as deinterlacing and line doubling. Then, the process would employ frame-store techniques to provide a frame-repeated output at a rate of 96 fps. These types of display-related improvements, in conjunction with the instant invention, should also be considered to be within the scope of the invention as disclosed herein. Examples of these various combinations and conversion methods are included in the table of FIG. 7A and the chart of FIG. 7B.

In general, the features as described need not all be provided in a single unit, but rather may be distributed through various external units (such as external data-recorders or display units). In addition, particular configurations of the system may include only the graphics capabilities required for that application (such as the use of 25 fps PAL outputs, but not 30 fps NTSC) and may even exclude certain options (such as printer outputs), and these variations should be considered to be within the scope of the invention.

A different preferred embodiment relates to a system for distributing a video program by way of multiple delivery channel paths. Current systems utilize a single medium (such as a Cable path or a Satellite path) for all transmissions. Furthermore, the typical approach is to utilize MPEG-2 compressed signals, as are employed in DVDs and DirecTV. However, it is not necessary to rely on this level of quality for all applications. The capabilities of the newer MPEG-4 compression system allow high quality signals at data rates of 1 Mb/sec or less, as compared to the approximately 5 Mb/sec common for MPEG-2 programs. Even lower data rates may be achieved, using special encoding methods; however, even at 1 Mb/sec, new approaches for VOD (Video On Demand) are possible.

A further complication is that people tend to think of the Internet as “free bandwidth.” As a result, there is a tremendous amount of data traffic which is conveyed over this path. However, using a new approach, Cable and Satellite systems also can become a source of “free bandwidth,” by making large amounts of the bandwidth over these paths available for new uses.

At a data rate of 1 Mb/sec, only approximately one-fifth of the bandwidth of the transmission medium is required. Therefore, if 1 Gb/sec of bandwidth is available, a 200-channel programming schedule only would require 200 Mb/sec, leaving 800 Mb/sec free to use for other data services. One possible use for this “new” bandwidth is for VOD.

In this new approach, Cable, Satellite, and Internet bandwidth are managed as a single system. For example, a movie program lasting 100 minutes could be split into 10 chapters, each 10 minutes long. Of these 10 chapters, the odd-numbered parts (1, 3, 5, 7, and 9) might be transmitted by Cable, while the even-numbered parts (2, 4, 6, 8, 10) could be transmitted by Satellite. In other schemes, at least part of the program would be transmitted over the Internet. The purchase of the program could be arranged via an Internet connection to a Command Center, which evaluates the possible delivery paths based on usage and available bandwidth (and considering what kinds of connection paths are available to the user/buyer). The Command Center also would relay information about how the program is being split and transmitted through the available paths, and how the parts are to be re-assembled at the user location.

Because of the much higher compression ratios achieved in MPEG-4 systems, a program may be transmitted more quickly than real-time. For example, if a 20 Mb/sec Satellite channel is utilized for a 1 Mb/sec signal, the material is transmitted at 20 times real-time, or 1 minute of program material every 3 seconds. In this case, the entire 100 minute program would be transmitted in only 5 minutes.

By utilizing a “cable box” or other receiving instrument having a hard-disk drive, it is possible to create near-VOD, in which a program is transmitted in the 5-minute period after a transaction is approved (or more quickly, if other paths or additional channels are available). In alternative methods, even quicker response is possible. During the night (or at any other time of low bandwidth usage), promotional “trailers” can be transmitted for currently-running programs, and stored for possible later use.

In addition, it also is possible to transmit, and store locally, the first 5 minutes of each of these programs, since each of these program segments would require less than 40 MB (which is a small amount of space on a disk drive holding tens of GB). In this case, playback of the program would begin immediately after the transaction is approved, and the segments following would be received and assembled while the initial program segment is being shown.

Another option is available through dynamic management of bandwidth. In this case, the transmission paths for the program segment(s) can be altered during the transmission process, to utilize the availability of additional bandwidth or to compensate for the deterioration of an existing path.

Alternatively, an accelerated transmission of the early segments would allow for better management of the following segments, perhaps transmitting them at a lower data rate, or intermittently.

Another alternative is available if a popular program is transmitted on a continuing basis. In this case, it only is necessary to transmit enough information to “fill the buffer” (for example, 5-minutes of programming), to allow the program to begin while the remaining segments are received (possibly, starting in the middle of the program, and continuing until the same point is reached in the next cycle). The “assembly instruction data” mentioned above would be used to re-assemble the segments to create the complete program.

Still another alternative would be to transmit the first 5-minute segment of a program using the full (20 Mb/sec) bandwidth. This would require only 15 seconds, and even could be done during the transaction time while the plan is determined for the paths to be used for the remaining segments. After this period, these remaining segments could be transmitted using less bandwidth, slower paths, or other paths than the initial connection.

It should be appreciated that the paths that may be utilized are not limited to just those indicated in the examples above. Various types of DSL links, wireless links, broadcast signals (such as conventional VHF or UHF transmissions), or cellular telephone links following the next (third-generation standards all are capable of participating in the overall plan to optimize bandwidth utilization. Similarly, the type of signal to be carried and managed through this system is not limited to movies or other such programs, but can include any signal (such as a signal which has high graphical content, an MP3 audio file, or a video clip) which places high demands on the bandwidth of the transmission medium, in order to be delivered. Any type of signal which is a contributing factor in the ongoing trend towards overloading the Internet also is a candidate for participation in this overall bandwidth-management system.

According to a further embodiment of the instant invention, the method of performing the frame rate transformation is adjusted in order to assure that every resulting frame is constructed from non-mixed fields. The usual process performed to produce a 60i signal from a 24 fps original source is to utilize a “3:2 pulldown” sequence. In this case, the first four film frames will result in a 10-field video frame sequence of A-A, A-B, B-C, C-C, and D-D. This results in mixed video frames 2 and 3 being constructed from two different film frames.

In order to maximize image compression efficiency and to minimize the complexity of editing, the frames surrounding the selected edit points at a scene change can be buffered, so that the frames can be re-constructed, if necessary, to produce “pure” rather than mixed frames. The frames would be intelligently selected or constructed, using techniques such as field or frame dropping, frame repeating, and so forth, as necessary. This technique would be applied both to the series of frames leading up to an edit point, and also to the series of frames which follow the edit point.

In general, it is most efficient for every scene of a series of interlaced frames to end with a frame constructed from an odd field and an even field which both are derived from the same film frame, and for the new scene begin with a frame constructed of an odd field and an even field which both are derived from the same film frame.

The process by which mixed frames may be eliminated from a video stream assembled by inserting repeated fields to create a higher-frame-rate output signal may be understood by reference to FIG. 7J. In television parlance, a mixed frame results when an interlaced frame is assembled from two fields which did not originate from the same image frame. The most commonly seen example of this effect is the field sequence which results from the usual 3:2 pull-down process utilized to convert film original material at 24 frames-per-second to NTSC interlaced video at 30 frames-per-second (60 fields-per-second). In order to execute the 3:2 sequence, the first film frame is utilized to create the first three video fields; then the next film frame is utilized to create the fourth and fifth video fields. The same process is used to produce the next five video fields, at which point the process repeats for the next set of four film frames and five video frames. If the four film frames are designated A, B, C, and D, then this will produce a 10-field video frame sequence of A-A′, A-B′, B-C′, C-C′, and D-D′, wherein, for example, A and A′ are, respectively, odd and even fields derived from the A original frame; this results in mixed video frames 2 and 3 each being constructed from video fields derived from two different film frames, as A-B′ and B-C′. If either of these mixed frames is chosen as the cut point for a video edit or splice, then there will be one field (the B′-field in frame 2 or the C′-field in frame 3) which is related to the following (edited-out) video frame, thereby causing a disturbance in the video program content flow at that edit point.

This problem may be addressed by following the process disclosed in FIG. 7J. The original 24 fps source signal (whether interlaced or progressive) first is converted to a 30 fps interlaced signal, conventionally denoted as 60i, with the 10-field video frame sequence described above, as A-A′, A-B′, B-C′, C-C′, and D-D′. Next, this 60i signal is de-interlaced to a 60p progressive signal, in which these ten resulting frames have the sequence A″, A″, A″, B″, B″, C″, C″, C″, D″, and D″. As an alternative, this sequence can be produced by converting the original 24 fps source signal directly to a progressive video frame sequence, with the progressive frames repeated as necessary to provide the desired output video frame rate.

At this point, each of these ten frames is “un-mixed”, in that it is constructed entirely from information derived from a single original image frame. As a progressive video signal, it may be cut or edited at any point, and the result would continue to be a sequence of un-mixed video frames. However, if this signal is to be converted to an interlaced signal, it is important to ensure that mixed frames will not be re-introduced by the editing process. This is done by controlling the process by which interlacing is introduced to the video frame sequence.

In the normal process of re-interlacing a progressive video signal, consecutive progressive frames are paired, with the first progressive frame providing the odd interlaced field, and the second progressive frame providing the even interlaced field. In order to avoid re-introducing mixed frames at a desired edit point, the two progressive frames supplying the interlaced fields must be from the same original image frame, at least at the selected edit point.

As an example, assume that video stream has the sequence disclosed in FIG. 7J. It may be desired to edit the sequence between the fourth and fifth progressive frames. If the video stream is cut at this point, and if progressive frames three and four (derived from original frames A and B, respectively) are utilized to produce the new interlaced frame, then use of this pair would result in a mixed frame. In order to avoid this mixed frame, the progressive frame sequence would be analyzed, to determine whether a scene change occurs between source frames A″ and B″ or B″ and C″. If a scene change occurs between source frames A″ and B″, then the progressive frame sequence at the desired edit point should utilize the sequence A″, B″, B″, C″, and D″ for the five resulting interlaced frames; if a scene change occurs between source frames B″ and C″, then the progressive frame sequence at the desired edit point should utilize the sequence A″, B″, C″, C″, and D″ for the five resulting interlaced frames. If scene changes occurred at both of these locations, then the progressive frame sequence at the desired edit point also should utilize the sequence A″, B″, B″, C″, and D″ for the five resulting interlaced frames.

An alternative method for constructing the frame sequence would be to simply discard half of the progressive frames. The same scene change considerations described above would apply, resulting in the same output sequences.

Although this process has been described for the case of a 24 fps source signal which is converted to a 30 fps output signal, in practice the method may be applied equally well for any frame rate conversion in which repeated fields have been added to the original source signal as part of increasing the output field or frame rate.

A second example encompasses the conversion of a 60I signal derived from a 24 frame per second original source (or any other signal having repeated fields added in order to increase the output field or frame rate. This process may be understood by reference to FIG. 7K. As in the previous example, the 24 frame per second original signal has been converted to a 60P signal. If it is desired to convert this 60P signal to a 50P or 50I signal, a conventional approach would be to convert the signal to a 48P or 481 signal, and then convert that signal to 50P or 50I by performing a 4% speed-up. This, however, requires utilizing a buffer capable of storing sufficient frames to perform the speed-up process, as described herein above. An alternative is available which does not require buffering more than 18 frames.

As shown in FIG. 7K, the “3:2 pull-down” process produces the 18-frame sequence A″, A″, A″, B″, B″, C″, C″, C″, D″, D″, E″, E″, E″, F″, F″, G″, G″, G″. Simple deleting the third repeated frame in a “triple” will result in a 48 frame per second signal stream, as A″, A″, B″, B″, C″; C″, D″, D″, E″, E″, F″, F″, G″, G″, in effect reversing the 3:2 pull-down process. However, if only two of every three “triples” is deleted, the resulting sequence is A″, A″, B″, B″, C″, C″, D″, D″, E″, E″, E″, F″, F″, G″, G″, which will produce a 50P sequence without resorting either to a speed-up process or inter-frame interpolation. Conversion to 50I may be performed either by simply discarding alternate frames, or by performing a re-interlacing process utilizing the intelligently directed frame selection process described in reference to FIG. 7J, above.

A comparable process may be utilized to convert a 50P or 50I signal into a 60P or 60I signal; this process may be understood with reference to FIG. 7L. In this case, it is necessary to perform the reverse of the process described in reference to FIG. 7K. Here, the sequence of A″, A″, B″, B″, C″, C″, D″, D″, E″, E″ is adapted with the addition of repeated frames to produce the sequence A″, A″, A″, B″, B″, C″, C″, C″, D″, D″, E″, E″. The signal stream may be converted to an interlaced or progressive signal by utilizing the same techniques described in reference to FIG. 7J for selecting frames or fields based on analysis of scene changes and video content.

Different considerations apply for cases in which the original material is in an interlaced format. As an example, FIG. 7M discloses a technique for performing a frame rate conversion of a 60I signal into a 50I signal. The initial field/frame sequence is A-A′, B-B′, C-C′, D-D′, E-E′, and F-F′. The first step is to convert the sequence to a 60P signal, denoted, for example, by A″, A″, B″, B″, C″, C″, D″, D″, E″, E″, F″, F″. This is then converted to a 50P signal stream by deleting every sixth frame, as A″, A″, B″, B″, C″, D″, D″, E″, E″, E″, F″. At this point, the signal stream is converted back into a 50I interlaced format. If there are no scene changes, then an acceptable sequence for the new stream would be A-A′, B-B′, C-D′, D-E′, E-F′. However, if a scene change occurs between original frames C and D, then a preferable sequence would be A-A′, B-B′, C-C′, D-D′, E-F′. Similarly, if a scene change occurs between original frames D and E, an alternative format would be: A-A′, B-B′, C-C′, D-D′, E-F′. Other considerations may call for a different sequence, but in each case, the 50P frames chosen for building the interlaced frames must be chosen so as to ensure that both of the frames that precede and follow a scene change should be built from un-mixed frames, as disclosed herein above.

A complementary situation exists for the conversion of a 50I signal into a 60I; this case is shown in FIG. 7N. Here, the initial sequence of frames is A-A′, B-B′, C-C′, D-D′, and E-E′. These interlaced frames then are converted to progressive frames, resulting in a 50P sequence as A″, A″, B″, B″, C″, C″, D″, D″, E″, E″. Now, the frame rate is increased to 60P, by repeating every fifth progressive frame, as A″, A″, B″, B″, C″, C″, C″, D″, D″, E″, E″, E″. As before, if there are no scene changes, then it is acceptable to create the interlaced sequence as A-A′, B-B′, C-C′, C-D′, D-E′, and E-E′. However, if there are scene changes near desired edit points, then the sequence may be altered, as described herein above, to produce a sequence with no mixed frames at the points of interest.

In general, the rule that is to be applied for conversion of an interlaced signal at a first frame rate into an interlaced signal at a second frame rate is to convert the signal at the first frame rate into a progressive signal, then perform the manipulations of the frame rate by adding or deleting frames, and then converting the signal back into an interlaced format by employing an intelligent process for selecting the progressive frames to be used for each interlaced frame, based on program content, scene changes, or the like. When creating new frames, or shifting fields to prevent mixed frames, it typically will be best to shift those frames that have alterations to occur after edit points, as research has shown that the first frames after scene changes are not fully perceived by viewers. Regardless of the method selected, there are many different techniques that will lead to acceptable results, and these variations should be considered to be within the scope of the invention.

In all cases, audio accompanying the video signals may be adjusted to complement the video frame rate conversions by employing any of the conventional techniques for time compression or time expansion, all well known in the art. As part of the process, frames may be adjusted through pixel interpolation and other techniques to produce any desired or required frame image size.

It will be appreciated by a practitioner skilled in the art that a 24 frame per second signal may be converted to 50 fields per second or 50 frames per second and back to 24 frames per second with no loss of images by employing the frame selection, speed-up, and slow-down techniques described herein above; similarly, a 24 frame per second signal may be converted to 60 fields per second or 60 frames per second and back to 24 frames per second with no loss of images, by utilizing 3:2 pull-down and reverse-3:2 pull-down techniques. In addition, a conversion from a 50I, 25P, or 50P signal to a 60I, 30P, or 60P signal can be reversed by locating the modified frames and restoring the original fields or frames. However, a 60I, 30P, or 60P original signal cannot reliably be converted to 50I, 25P, or 50P signal and then reconstructed as the original 60I, 30P, or 60P signal, because fields or frames may have been lost in the process.

We claim:

1. A method of performing a frame-rate transformation on a video program so that it may be edited or otherwise manipulated using only non-mixed fields, the method comprising the steps of:
a) providing an input video program having mixed frames and edit points, certain of which may be associated with scene changes;
b) buffering the frames or fields surrounding selected edit points so that the frames can be re-constructed, if necessary, to produce non-mixed frames; and
c) selecting, dropping or repeating the frames or fields to output a program having a desired frame rate.

2. The method of claim 1, wherein steps b) and c) are applied to frames before and after the selected edit point.

3. The method of claim 1, wherein the mixed frames are created by inserting repeated fields in the program to create a video program at a higher frame rate.

4. The method of claim 3, wherein the fields are inserted using a 3:2 pulldown sequence

5. The method of claim 1, wherein:
the input video program is a 24 fps interlaced or progressive signal; and
the output video program is a 60 fps, progressive signal.

6. The method of claim 5, including the steps of:
converting the input video program to a 30 fps interlaced signal; and
de-interlacing the signal to produce the 60 fps progressive signal.

7. The method of claim 5, including the steps of:
converting the input video program directly by repeating progressive frames as necessary to provide the desired output frame rate.

8. The method of claim 1, wherein:
the output video program is an interlaced signal; and
steps are taken to ensure that mixed frames will not be re-introduced by editing or otherwise manipulating the program.

9. The method of claim 8, wherein:
the two progressive frames supplying the interlaced fields are derived from the same original image frame, at least at the selected edit point.

10. The method of claim 8, including the step of discarding half of the progressive frames to achieve the desired output frame rate.

11. The method of claim 1, wherein:
the input video program is a 60 fps progressive signal; and
two of every three triple frames are deleted to produce a 50 fps progressive signal.

12. The method of claim 11, wherein:
conversion to a 50 fps interlaced signal is performed by discarding alternate frames.

13. The method of claim 11, wherein:
conversion to a 50 fps interlaced signal is performed using a re-interlacing process based on selected frames.

14. The method of claim 1, wherein:
the input video program is a 50 fps interlaced or progressive signal;
the output video program is a 60 fps interlaced or progressive signal; and
the method includes the steps of:
repeating frames, as necessary, and analyzing scene changes, video content, or both to convert the signal to an interlaced or progressive signal.

15. The method of claim 1, wherein:
the input video program is an interlaced signal at a first frame rate;
the output video program is an interlaced signal at a first second rate; and
the method includes the steps of:
converting the signal at the first frame rate into a progressive signal,
manipulating the frame rate by adding or deleting frames, and
converting the signal back into an interlaced format by selecting the progressive frames to be used for each interlaced frame in accordance with program content or scene changes.

16. The method of claim 15, wherein:
in creating new frames or shifting fields to prevent mixed frames, priority is given to frames that have alterations to occur after edit points.

17. The method of claim 1, wherein:
the input video program is a 60 fps interlaced signal having a field/frame sequence of A-A′, B-B′, C-C′, D-D′, E-E′, and F-F′;
the output video program is a 50 fps interlaced signal; and
the method includes the steps of:
converting the input signal to a 60 fps progressive signal with a field/frame sequence of A″, A″, B″, B″, C″, C″, D″, D″, E″, E″, F″, F″,
converting the sequence immediately above to a 50 fps progressive signal by deleting every sixth frame, as A″, A″, B″, B″, C″, D″, D″, E″, E″, E″, F″, and
converting the signal back into a 50 fps interlaced format.

18. The method of claim 17, wherein:
there are no scene changes; and
the desired frame sequence is A-A′, B-B′, C-D′, D-E′, E-F′.

19. The method of claim 17, wherein:
there is a scene change between frames C and D; and
the desired frame sequence is A-A′, B-B′, C-C′, D-D′, E-F′.

20. The method of claim 17, wherein:
there is a scene change between frames D and E; and
the desired frame sequence is A-A′, B-B′, C-C′, D-D′, E-F′.

21. The method of claim 1, wherein:
the input video program is a 50 fps interlaced signal having a field/frame sequence of A-A′, B-B′, C-C′, D-D′, and E-E′;
the output video program is a 60 fps interlaced signal; and
the method includes the steps of:
converting the input interlaced frames into progressive frames, resulting in a 50 fps, progressive sequence A″, A″, B″, B″, C″, C″, D″, D″, E″, E″; and
increasing the frame rate to 60 fps by repeating every fifth progressive frame, as A″, A″, B″, B″, C″, C″, D″, D″, E″, E″, E″.

22. The method of claim 21, wherein:
there are no scene changes; and
the desired frame sequence is A-A′, B-B′, C-C′, C-D′, D-E′, and E-E′.

23. The method of claim 21, wherein:
there is a scene change with one or more edit points; and
the sequence is altered to produce a sequence with no mixed frames at the edit points.

24. The method of claim 1, wherein:
the input video program is a 24 fps interlaced or progressive signal; and
the program is converted into a program with 50 fields or 50 frames per second and back into a 24 fps signal with no image loss using frame selection, speed-up, or slow-down techniques.

25. The method of claim 1, wherein:
the input video program is a 24 fps interlaced or progressive signal; and
the program is converted into a program with 60 fields or 60 frames per second and back into a 24 fps signal with no image loss using a 3:2 pull-down and reverse-3:2 pull-down technique.

26. The method of claim 1, wherein:
the input video program is a 25 fps progressive or 50 fps interlaced or progressive signal which is converted into a 25 fps progressive or 60 fps interlaced or progressive signal and reversed by locating the modified frames and restoring the original fields or frames.

27. The method of claim 1, wherein:
the video program includes an audio accompaniment; and
the video signals are adjusted using time compression or time expansion to accommodate the accompaniment.
